(19) United States
(12) Patent Application Publication
(10) Pub. No.: US 2016/0314543 A1
(43) Pub. Date: Oct. 27, 2016

(54) System and method for improved inspection techniques

(71) Applicants: Srini KRISH, Lewis Center, OH (US); Raymond DELANEY, Newark, DE (US); Brian STOCKER, Lewis Center, OH (US); Matt MARQUAND, Columbus, OH (US); Smita AYANAMPUDI, Hilliard, OH (US); Charles Alan HAGAN, Lexington, OH (US)

(72) Inventors: Srini KRISH, Lewis Center, OH (US); Raymond DELANEY, Newark, DE (US); Brian STOCKER, Lewis Center, OH (US); Matt MARQUAND, Columbus, OH (US); Smita AYANAMPUDI, Hilliard, OH (US); Charles Alan HAGAN, Lexington, OH (US)

(73) Assignee: JPMorgan Chase Bank, N.A., New York, NY (US)

(21) Appl. No.: 13/159,688

(22) Filed: Jun. 14, 2011

(51) Int. Cl. G06Q 10/00

(52) U.S. Cl. CPC G06Q 50/04

(57) ABSTRACT

Improved techniques for documenting and correcting deficiencies indentified during inspections are provided. Exemplary embodiments may use a portable electronic device, running an application to document inspection results. The application may provide a series of user interfaces and menus to support recordation of the inspection results. This portable electronic device may interface with a computer system over a computer network. Through this interface, an inspector may upload inspection results, which may include digital images, generate reports, and provide notification of deficiencies. Work orders may be generated and forwarded to appropriate entities for correction. The system may enable real-time collaboration during inspections and also during correction of deficiencies.

### FIELD OF THE INVENTION

The invention relates generally to providing tools to improve the efficiency for identifying and correcting deficiencies such as those identified during inspections of physical objects.

### BACKGROUND OF THE INVENTION

When performing a site inspection, such as of a building or other physical plant structure or equipment, an inspector documents the condition of the facility. The documentation is typically performed using hand written forms or notes. The inspection is used to document the condition of the structure and to note deficiencies for later correction. In some cases, an electronic device such as a laptop computer is used for electronic entry of the inspection results. However, the inspection results, such as deficiencies requiring correction, must typically be then entered into a separate work order system. Entry into the work order system is required for assignment of the work to appropriate parties for correction of the deficiencies. This entry or transferring of items from one system to another is administratively intensive. The work order system typically performs generation of a work request. This work request is then forwarded to the appropriate parties for correction. These parties are, in many cases, third party contractors. The contractors own work order systems typically do not interface with the work order system which generated the original order. Hence, further entry or transferring of the work order information is required. The same issues arise with documenting completion of the work order.

These and other deficiencies exist.

### SUMMARY OF THE INVENTION

Exemplary embodiments include a computer implemented method comprising receiving, by a computer processor, a request for data from a first computing device associated with a first user, wherein the computer processor is part of a first computing system; transmitting, electronically, the requested data to the first computing device; receiving, by the computer processor, from the first computing device, information comprising one or more deficiencies, wherein the deficiencies are defects or problems associated with a facility, structure, or piece of equipment; preparing, by the computer processor, a work order based on the one or more deficiencies; and transmitting, electronically, the work order to a second computing system.

Exemplary embodiments include a computer implemented system comprising a server comprising at least one computer processor; a first computing device; a network communicatively coupling the server and the first computing device; and the server configured to: receive a request for data originating from an application on the first computing device; transmit the requested data to the first computing device; receive information, from the first computing device, comprising one or more deficiencies, wherein the deficiencies are defects or problems associated with a facility, structure, or piece of equipment; prepare, based on the one or more deficiencies, a work order; and transmit the work order to a second server.

Advantages of this invention in addition to those described above are apparent from the following detailed description of the exemplary embodiments.

### BRIEF DESCRIPTION OF THE DRAWINGS

FIG. 1 is a flow chart of a method for inspections in accordance with an exemplary embodiment of the invention.

FIG. 2 is a system for site inspections in accordance with an exemplary embodiment of the invention.

FIG. 3 is a system for site inspections in accordance with an exemplary embodiment of the invention.

FIG. 4 is an exemplary user interface screen for a site inspection application in accordance with an exemplary embodiment of the invention.

FIG. 5 is an exemplary user interface screen for a site inspection application in accordance with an exemplary embodiment of the invention.

FIGS. 6a and 6b are exemplary user interface screens for a site inspection application in accordance with an exemplary embodiment of the invention.

FIGS. 7a and 7b are exemplary user interface screens for a site inspection application in accordance with an exemplary embodiment of the invention.

FIG. 8 is an exemplary user interface screen for a site inspection application in accordance with an exemplary embodiment of the invention.

FIG. 9 is an exemplary user interface screen for a site inspection application in accordance with an exemplary embodiment of the invention.

FIG. 10 is an exemplary user interface screen for a site inspection application in accordance with an exemplary embodiment of the invention.

FIG. 11 is an exemplary user interface screen for a site inspection application in accordance with an exemplary embodiment of the invention.

FIG. 12 is an exemplary user interface screen for a site inspection application in accordance with an exemplary embodiment of the invention.

FIG. 13 is an exemplary user interface screen for a site inspection application in accordance with an exemplary embodiment of the invention.

FIG. 14 is an exemplary user interface screen for a site inspection application in accordance with an exemplary embodiment of the invention.

FIG. 15 is an exemplary user interface screen for a site inspection application in accordance with an exemplary embodiment of the invention.

FIG. 16 is an exemplary user interface screen for a site inspection application in accordance with an exemplary embodiment of the invention.

FIG. 17 is an exemplary user interface screen for a site inspection application in accordance with an exemplary embodiment of the invention.

FIG. 18 is an exemplary user interface screen for a site inspection application in accordance with an exemplary embodiment of the invention.

FIG. 19 is an exemplary user interface screen for a site inspection application in accordance with an exemplary embodiment of the invention.

FIG. 20 is an exemplary user interface screen for a site inspection application in accordance with an exemplary embodiment of the invention.

FIG. 21 is an exemplary user interface screen for a site inspection application in accordance with an exemplary embodiment of the invention.

FIG. 22 is an exemplary user interface screen for a site inspection application in accordance with an exemplary embodiment of the invention.

FIG. 23 is a flow chart of a method for proactive reporting n accordance with an exemplary embodiment of the invention.

These and other embodiments and advantages of the invention will become apparent from the following detailed description, taken in conjunction with the accompanying drawings, illustrating by way of example the principles of the various exemplary embodiments.

### DETAILED DESCRIPTION OF THE PREFERRED EMBODIMENTS

It will be readily understood by those persons skilled in the art that the embodiments of the inventions described herein are capable of broad utility and application.

Accordingly, while the invention is described herein in detail in relation to the exemplary embodiments, it is to be understood that this disclosure is illustrative and exemplary of embodiments of the invention and is made to provide an enabling disclosure of the invention. Accordingly, the disclosure is not intended to be construed to limit the embodiments of the invention or otherwise to exclude any other such embodiments, adaptations, variations, modifications and equivalent arrangements. While the various embodiments of the present invention are described in the context of inspections of physical plants and property, the methods and systems described herein may be applied to other related items, such as other types of inspections and quality control environments in manufacturing and industry.

The following descriptions are provided of different configurations and features according to exemplary embodiments. These configurations and features may relate to providing support for inspections. Such support may be provided through inspectors and interaction electronically over a computer network, such as the Internet. While certain nomenclature and types of applications/hardware are described, other names and application/hardware usage is possible and the nomenclature provided is done so by way of non-limiting examples only. Further while particular embodiments are described, these particular embodiments are meant to be exemplary and non-limiting and it further should be appreciated that the features and functions of each embodiment may be combined in any combination as is within the capability of one of ordinary skill in the art. For example, while the following methods and systems may be illustrated using certain examples relating to a site inspection of a facility, such as a building or other location, these examples are meant to be exemplary and non-limiting.

The attached Figures provide additional details regarding the present invention.

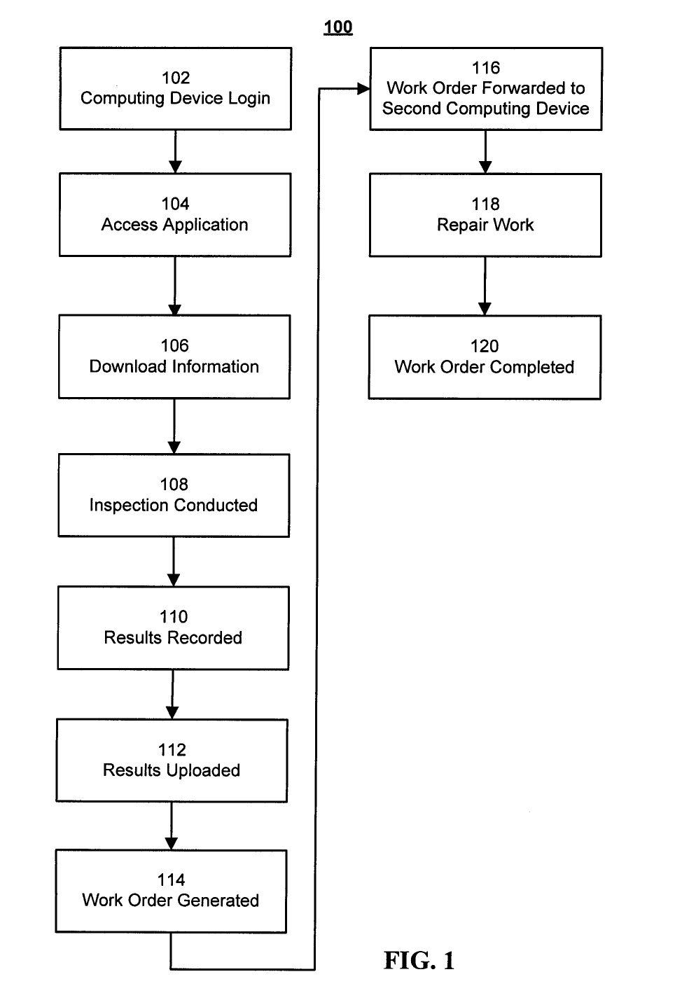

FIG. 1 depicts a flow chart of a method of conducting an inspection using a computing device according to exemplary embodiments of the invention. Exemplary method 100 is provided by way of example, as there are a variety of ways to carry out the methods disclosed herein. The method 100 as shown in FIG. 1 may be executed or otherwise performed by one or a combination of various systems, such as a computer implemented system. Each block shown in FIG. 1 represents one or more processes, methods, and/or subroutines carried out in the exemplary method 100. Each block may have an associated processing machine or the blocks depicted may be carried out through one processor machine.

At block 102, a computing device is logged into. The computing device may a be a portable electronic device. For example, the computing device may be a tablet computing device. Other portable electronic devices may be used such as, by way of non-limiting examples, mobile phones (e.g., cell or cellular phones), smart phones (e.g., iPhones, Android based phones, or Blackberry devices), personal digital assistants (PDAs) (e.g., Palm devices), netbooks, laptops, e-readers, or other portable computing devices. The computing device may have a touch sensitive display screen. The display screen may accept touch inputs from a human finger and/or a device, such as a stylus or pen. In some embodiments, input to the computing device may be performed using a keyboard or a pointing device. For example, a mouse, pointing stick, or touch-pad may be used to perform inputs. A virtual keyboard may be displayed on the screen of the second device for inputs; that is, the keyboard may be used via the touch screen. A combination of input devices and methods may be used. In some embodiments, the computing device may be privately owned, such as being owned by the user.

The computing device may be communicatively coupled to one or more computer networks through a wireless or wired connection. For example, data may be transmitted and/or received using an Ethernet connection, a fiber connection, a traditional phone wireline connection, a cable connection or other wired network connection. It should be appreciated that in the context of inspections, that network connectivity may not always be possible. In order to accommodate this fact, the computing device may have the capability to cache information for later upload and/or access when network connectivity is available. Communications may be electronically established over a wireless network. For example, the computing device may communicate and/or transmit/receive data using a wireless signal. The wireless signal may consist of Bluetooth, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and/or systems suitable for transmitting and receiving data. A standard wireless protocol may be used. For example, the wireless protocol may include IEEE 802.11a, 802.11b, 802.11g, and 802.11n.

The computing device may have one or more peripheral devices attached thereto. The peripheral device may be connected to a computer network either through its own connection or it may use the connection of the computing device. For example, the peripheral devices may have one or more input devices, such as a mouse, an external keyboard, and a scanner. The peripheral devices may be output devices, such as a printer.

According to exemplary embodiments, the computing device may have at least one digital imaging device associated therewith. For example, the digital imaging device may be a digital camera attached or integrated therein. The digital imaging device may be capable of capturing or taking digital images. The digital imaging device may be capable of capturing full motion video in addition to capturing digital images. The computing device may have two digital imaging devices to enable a video conference to occur. For example, the computing device may have a forward and rear facing camera. The computing device may be capable of accepting inputs from an external or peripheral digital imaging device. For example, the computing device may accept inputs from a separate digital camera or another computing device with an integrated or attached digital camera. The computing device may have a microphone associated therewith to enable audio input into the computing device. An external audio input device may be used.

The logon may occur by entering a user name or other identifier and a password. A password may not be required. In some embodiments, a gesture or sequence of movements on the screen of the computing device or movements of an input device may be used. A single sign-on “SSO”) type logon may be used.

At block 104, an application is accessed. The application may be accessed by the user by affirmatively selecting it and starting the application. The application may be the primary application present on the computing device. One or more applications, widgets, interfaces, and programs may be installed to support the embodiments described herein. For example, the computing device may be a dedicated device for the purpose of site inspections and the installed software or applications may support or be oriented towards that purpose. The application may be related to inspections of sites. For example, a user may select the site inspection application. In some embodiments, the application may automatically commence following the login.

According to some embodiments, the computing device may have a number of additional applications, widgets, interfaces, and/or programs installed. For example, the computing device may have certain software installed.

In some embodiments, the computing device may be a thin client, such that the majority of the processing may be performed in the other components of the system, or a thick client, such that the majority of the processing may be performed on the computing device. The computing device may be communicatively coupled to one or more servers or other computing devices that electronically interact during the method described herein.

At block 106, information is downloaded. The user may select, using the application, desired information and the computing device may download that information. For example, the user may select a plurality of locations which they intend to inspect during an upcoming time period. The information pertaining to those locations may be downloaded. For example, the downloaded information may include, facility plans and layouts, past inspection reports, maintenance history, open work orders, past or corrected work orders, and general facility information including names of points of contacts and managers. The information may be downloaded and cached by the computing device. The caching may enable the downloaded information to be accessed when network connectivity is not available or is unable to support data exchange. When network connectivity is available, real time data may be exchanged between the computing device and associated servers. The computing device may request periodic updates to the information. The periodic updates may be done at the user's request. Alternatively, updated information may automatically be pushed to the computing device.

At block 108, an inspection is conducted. The computing device may be used during the inspection. For example, the user may visit a location, such as a building or other facility, and conduct an inspection of the premises with the computing device in their possession during the inspection.

At block 110, the inspection results are recorded. The computing device may be used to capture the results through input of the results into the computing device. For example, the user, during and/or after the inspection, may record the results on the computing device. The results may be recorded using the application in one or more forms. An appropriate interface with menu selections for the user may be provided by the application for recordation of the inspection. In alternative embodiments, the results may be recorded using a free form format, such as a word processing document, into which the user writes their results and observations.

If the computing device has a digital imaging device, the digital imaging device may be used to record inspection results. Using the digital imaging device, images of the location may be captured and recorded to the computing device. Each image may be time and date stamped. The images may have locating coordinates associated with them or stamped on them based on a location finding capability on the computing device. These coordinates may be used to accurately locate the position of the image taken. For example, the computing device may have a GPS (Global Positioning Capability). Each image captured may have a stamp put on it with the GPS coordinates. Subsequently, those GPS coordinates may be entered into the computing device in order to locate the location where the image was captured.

In other embodiments, the user may enter a specific description of where the image was taken. Such location information may be used to assist others in locating the problem in order to facilitate repair thereof. In some embodiments, a location may have a bar code or a QR (Quick Response) code or their equivalent positioned around the location. These codes may be printed or imaged onto stickers or other indicators that are placed at various positions. The code may be etched into an object. The computing device may be used to image one of these codes. In some embodiments, a separate imaging device may be used. For example, a window may have a bar code affixed to it or located on a wall near the window. Likewise, a room may have a code affixed at an entry location. The computing device may be used to take a digital image of the code using its digital camera. This code may be read by the computing device. For example, the computing device may have software or hardware capable of reading and deciphering the code. The code may contain location and other information about an object or location with which the code is associated or located near. This code may be tagged or uploaded to the report and associated with the image or the deficiency report. This code may then be used to identify the location of the reported deficiency.

The computing device may have an audio input capability. For example, the computing device may have a microphone built into it. The user may record audio observations using the microphone capability of the computing device. The audio file may be saved as part of the report. In some embodiments, the audio file may be transcribed by the computing device. For example, the computing device may have voice recognition capability to turn spoken words into written words.

At block 112, the results are uploaded. The results may be uploaded to a central server and/or a datastore, such as a database, for further processing, distribution, and archiving. The server may be a computing device with one or more computer processors. The results may be uploaded based on user selection following a review of the inspection report. In some embodiments, the results may be uploaded in real time or cached for upload when connectivity becomes available. The processing may include mapping of the digital images taken to coordinates in the location to ensure ease of future reference.

At block 114, work orders are generated. The work orders may be automatically generated based on any deficiencies, problems, defects or issues documented during the inspection. For example, the user may note that a wall of a building has a crack in it. the deficiencies may be associated with equipment. For example, the user may note burned out lighting associated with an automated teller machine. This may have been recorded during the inspection. An image may have been taken of the crack. A work order may be generated to fix the crack upon processing of the inspection results. The work order may contain all of the detail from the inspection report, including any images or audio files. A work order for each deficiency may be created. In some embodiments, a work order may contain multiple deficiencies.

At block 116, the work order is forwarded. The work order may be electronically forwarded to an appropriate entity to address the order. The entity may be a third party. The third party may be a contractor or vendor. The third party may coordinate and/or perform the work to fix the deficiency indicated in the work order. In some embodiments, the third party may be associated with the owner of the location. For example, a corporation may have an indigenous repair or building maintenance department. The work order may be forwarded to a computing system associated with the entity. This computing system may be different from the system which generated the work order. For example, the work order may be forwarded to a server or computing device.

The entity may have a second computing device. The second computing device may be similar to the computing device described at block 102. The second computing device may be more than one computing device. The second computing device may have an application installed to support interfacing with the work order. This application may allow for viewing, editing, and updating of the work order.

At block 118, repair work is conducted. The entity (or its designated representative) may proceed to the location and perform the necessary repair work. The entity may have the second computing device in its possession. For example, the personnel performing the work may have the second computing device with them. The second computing device may be used in a manner similar to the computing device as described above. The application on the second computing device may allow the second computing device to be used to access information about the location, such as floor plans and digital images, including any codes (for example, bar codes), from the inspection. This information may be included with or linked to the work order. The second computing device may interface with the system which generated the work order or another computing system to access this information. The second computing device may be used to record the work results. For example, the user may make entries into an application that the work is completed and how it was completed. The digital imaging device may be used to take digital images of the work.

According to some embodiments, the entity, through its computer systems, such as those associated with the work order and the second computing device, may interface with the security systems of the entity which is associated with the location where the work is to be performed. Using such an interface, the entity may forward security information in advance of their arrival. For example, the entity, who may be a contractor, may forward a listing of names of personnel arriving to perform the work. The listing may be generated and forwarded using an application on the second computing device. Upon arrival at the location, security may verify that the personnel present match the security list.

The work order on the second computing device may provide access information for the location. Once security is cleared and identities are verified, an access module or interface on the second computing device may be enabled or activated. Security may provide a code to activate the module. The module may be activated by the presence of the second computing device at the location. The access module may provide access codes to proceed through security doors. The access codes pertaining to a route to the work area may be provided. These may be the only access codes provided. The codes may be alpha-numeric codes for entry onto keypads at various doors. Alternatively, the codes may be bar codes or QR codes that may be displayed on the second computing device for reading by an appropriate scanner. Security may track the second computing device based on access to these areas. According to some embodiments, these access codes may expire after a set period of time or based on the location of the second computing device. On the second computing device, a map may be provided to guide the personnel to the appropriate location and to the appropriate doors based on the access codes. In this manner, the routing of the entity's personnel may be controlled at the location.

To facilitate further security, the second computing device may have a position locating capability. For example, the second computing device may have a GPS (Global Positioning System) capability. This position capability may be used to track the location or position of the second computing device. In some embodiments, the wireless signal of the second computing device or another emitter may be tracked. The security system may have an interface capability to perform this tracking. Such tracking may enable security to know the position of the second computing device and hence its holder. In cases where the GPS signal may not be accessible, the entity with the second computing device may be required to check-in with security periodically.

At block 120, the work order is completed. Upon successful completion of the work order, the inspection report may be updated to reflect the completion. The completion of the work order may trigger a notification or message to the submitting user. The user may verify the completion of the work order to facilitate closure of the work order.

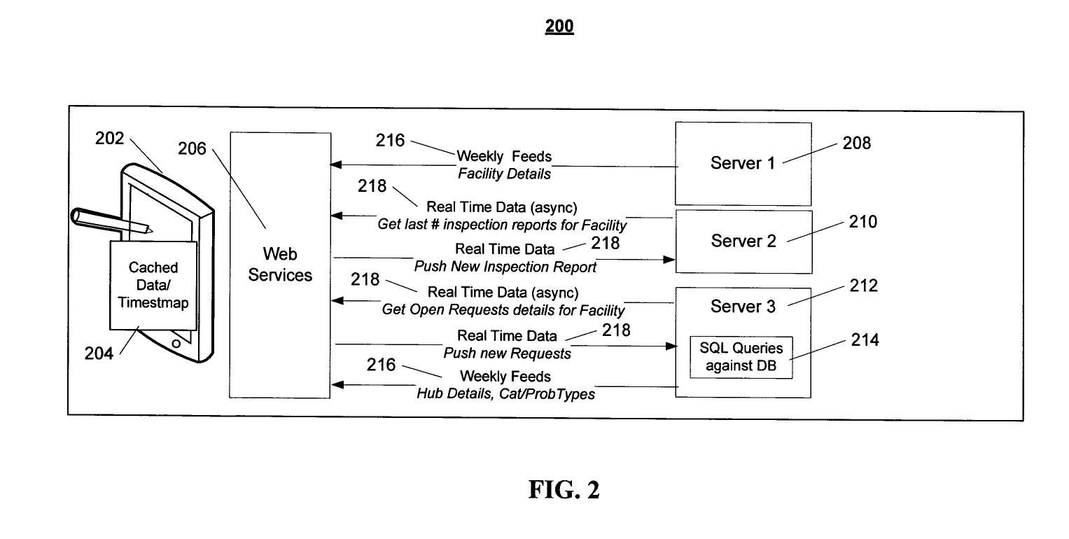

FIG. 2 is a system according to an exemplary embodiment of the invention. System 200 may provide various functionality and features associated with the program. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized. It should be appreciated that system 200 may be integrated into and run on a computer, which may include a programmed processing machine which has one or more processors. Such a processing machine may execute instructions stored in a memory to process the data. System 200 may be integrated into and run on one or more computer networks which may each have one of more computers associated therewith. Further, while a particular structure or type of component is shown, this structure is meant to be exemplary, as other structure or components may be able to be substituted to perform the functions described.

As noted above, the processing machine executes the instructions that are stored in the memory or memories or persistent data storage devices to process data. This processing of data may be in response to commands by a user or users of the processing machine, in response to previous processing, in response to a request by another processing machine and/or any other input, for example. As described herein, a module performing functionality may have a processor.

According to exemplary embodiments, the system 200 may be configured to carry out the methods as described herein. For example, the method 100 may be conducted by the system 200. The system 200 may support other methods and be communicatively coupled to other systems. FIG. 2 may have various connection arrows between its components. The connection arrows may indicate a direction of data exchange between the components. These directions are exemplary and non-limiting in nature.

System 200 may have a computing device 202. For example, the computing device 202 may be a tablet computing device as depicted in FIG. 2. Information may be cached and time stamped 204 on the computing device 202. The cached data may be used in situations where network connectivity is limited or not available. The timestamp may be associated with the cached data for tracking and recordation purposes. The timestamp may then be used when viewing data to determine the age of the data. For example, data may be marked “Current as of <time><date>” or an equivalent marking to allow identification of the data age. In cases where no cached data is available, a suitable message may be displayed. For example, “No cached data available” or “Waiting on Data” or equivalent messages may be displayed. A user may be notified when the data becomes available. These messages regarding data may be displayed with any data upon access to that data.

Web services 206 may be provided and be associated with the computing device. The web services may be an application residing on the computing device.

System 200 may have servers 208, 210, and 212 associated therewith. Additional servers may be present. In some embodiments, the functionality of servers 208, 210, and 212 may be combined into a single server. As depicted in system 200, server 212 may have a database 214 associated therewith. For example, server 212 and database 214 may be a facility server and database that may be used to track work requests and other maintenance information related to one or facilities or physical plants. The database may be an SQL type database or other type of database as known to one of ordinary skill in the art. Server 212 may use this database to conduct queries for information.

Data and information streams or feeds may be exchanged between the servers and computing device as depicted in System 200. Some of this information may be real time and other parts may be sent at various time intervals, such as weekly or daily. Some information may flow in one direction and other information may flow in both directions as shown. For example, there may be weekly feeds 216 which contain various information regarding the facility and problems with the facility, which may be categorized. There may be real time data exchanges 218 regarding facility data such as inspection reports and work requests. The web services 206 may serve as middleware for this information exchange. The web service 206 may broker the transmission and receipt of the various data and information feeds.

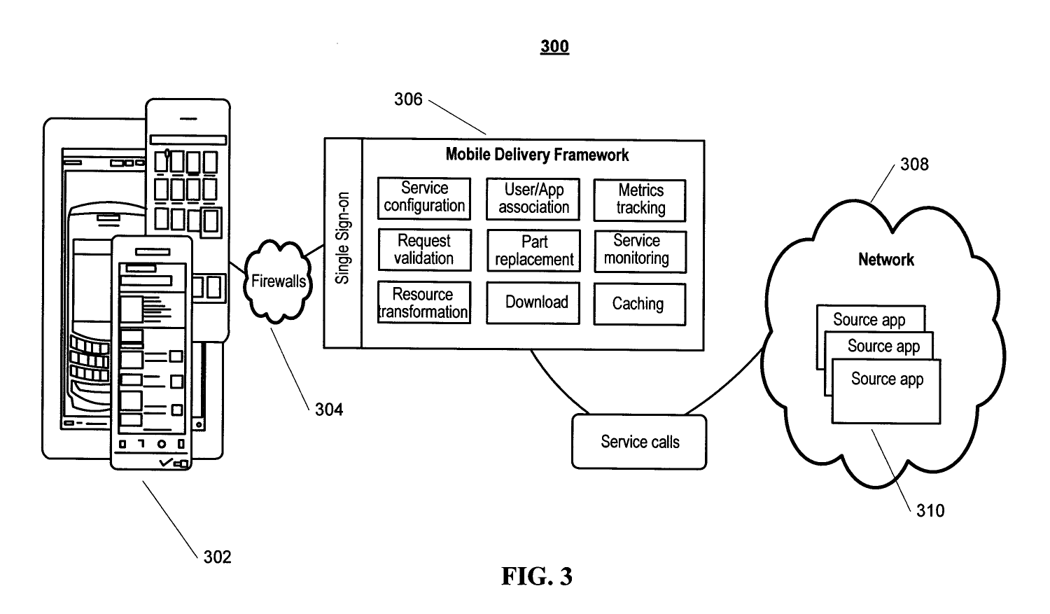

FIG. 3 is a system according to an exemplary embodiment of the invention. System 300 may provide various functionality and features associated with the program. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized. It should be appreciated that system 300 may be integrated into and run on a computer, which may include a programmed processing machine which has one or more processors. Such a processing machine may execute instructions stored in a memory to process the data. System 300 may be integrated into and run on one or more computer networks which may each have one of more computers associated therewith. Further, while a particular structure or type of component is shown, this structure is meant to be exemplary, as other structure or components may be able to be substituted to perform the functions described.

As noted above, the processing machine executes the instructions that are stored in the memory or memories or persistent data storage devices to process data. This processing of data may be in response to commands by a user or users of the processing machine, in response to previous processing, in response to a request by another processing machine and/or any other input, for example. As described herein, a module performing functionality may have a processor.

According to exemplary embodiments, the system 300 may be configured to carry out the methods as described herein. For example, the method 100 may be conducted by the system 300. Systems 200 and 300 may be integrated and may be part of the same system. The system 300 may support other methods and be communicatively coupled to other systems. The system 300 may have various connection arrows between its components.

System 300 may have one or more computing devices 302 associated therewith. The computing devices 300 may be various types of portable electronic computing devices as described above. In the case of multiple computing devices 302, the computing devices may be of different types. For example, the system 300 may have a tablet computing device, a blackberry type device, and a smart phone, or other portable electronic device associated therewith.

The computing devices may connected to a network through a firewall 304 or other connection interface.

After the firewall, a mobile delivery framework 306 may be present. The mobile delivery framework 306 may be associated with a server or other computing hardware or the mobile delivery framework may be associated with the computing device 302. For example, the mobile delivery framework 306 may be installed on the computing device 302. Alternatively, the mobile delivery framework may be installed on a server or other computer. The mobile delivery framework 306 may be communicatively coupled to a computer network 308. For example, the mobile delivery framework 306 may be communicatively coupled to an intranet or the Internet. The network components of the mobile delivery framework 306 may automatically detect the network and its accessibility. The network components may provide a hyper-text transfer protocol (“http”) based communication conduit for invoking other components. According to exemplary embodiments, inbound and outbound data may use the JavaScript Object Notation (“JSON”) format. It should be appreciated that other formats as known may be used. For example, Extensible Mark-up Language (“XML”) or Hyper-text Mark-up Language (“HTML”) may be used.

The mobile delivery framework 306 may have a number of components or modules. The components depicted in System 300 are exemplary only. Other components may be present. The mobile delivery framework 306 may include the application for site inspection. Each component or module of the mobile delivery framework 306 may be a part of the application.

The computer network 308 may have one or more applications 310 running over it or be supported by it.

The mobile delivery framework 306 may communicate with the applications 310 over the computer network 308 through various service calls. The service calls may be in any format for exchange of information as appreciated by one of ordinary skill in the art. For example, JSON, or other data exchange formats, as described above may be used. The components of the mobile delivery framework 306 may be singletons in the overall inspection application such that each one will return data, such as cached data, to the user when requested. The framework 306 may have one or more caching components which may return cached model objects to each call, convert response data into model objects, and send model objects to the persistence layer and broadcast events to interested parties when new cached data is available.

To provide security, each networked server invocation may require a security token. Any request not containing a valid token may be met by a challenge. The framework application may manage this token and may prompt the user for authentication as required. After the application is launched, the first network call may challenge the user for credentials and the security token will be stored in memory for subsequent requests. The security token may time out after a period of inactivity, so a new security token may be requested. In some cases, after a certain period, the application will drop the security token and require a new authentication from the user.

In accordance with exemplary embodiments, the site inspection application and system may have a number of different areas of functionality. For example, the areas of functionality may include, a user interface, various services, caching capability, persistence, security, and networking capability.

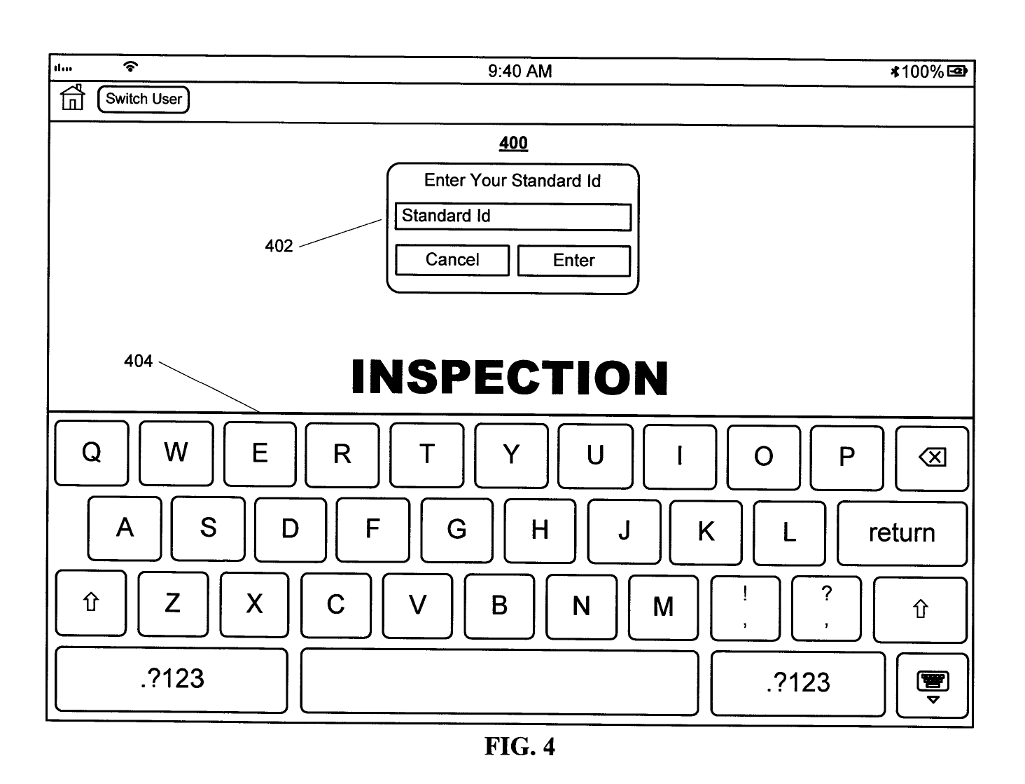

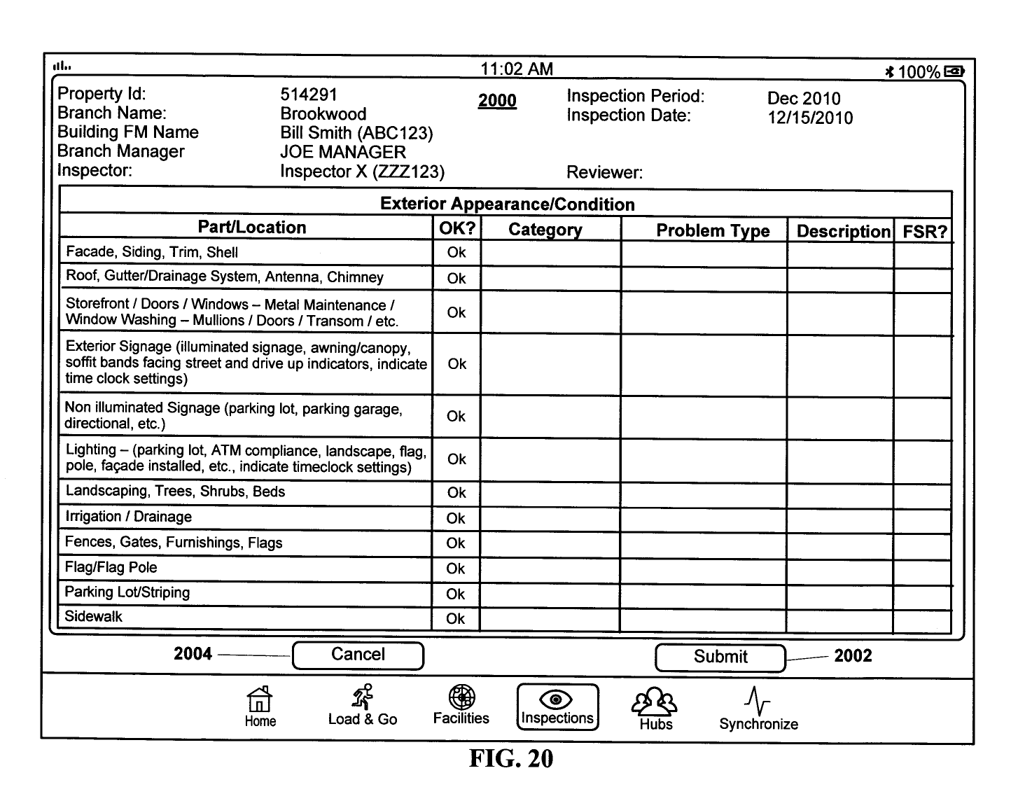

FIGS. 4 through 22 show exemplary user screens for an application for site inspections in accordance with exemplary embodiments. These screens may be used with a computing device as described above. For example, the computing device may be a tablet computing device. It should be appreciated that such user screens are meant to be exemplary only and that the screens may have more or less features than depicted herein.

FIG. 4 depicts a log-on screen 400. The log-on screen 400 may appear when the computing device is powered on. In some embodiments, the log-on screen 400 may appear when a site inspection application is started. The log-on screen 400 may be the entry or gateway to the application. The log-on screen 400 may have a box 402 with a location for entry of a user identification. For example, the user identification may be a standard id. The log-on may be a single sign-on (“SSO”) logon. The box 402 may have buttons to allow processing of the identification following entry. A cancel button may be provided. An entry keyboard 404 may be provided on the screen to facilitate entry of the user identification. The entry keyboard 404 may be a virtual keyboard operated through the computer device's touch screen. The entry keyboard 404 may be a QWERTY type keyboard as shown.

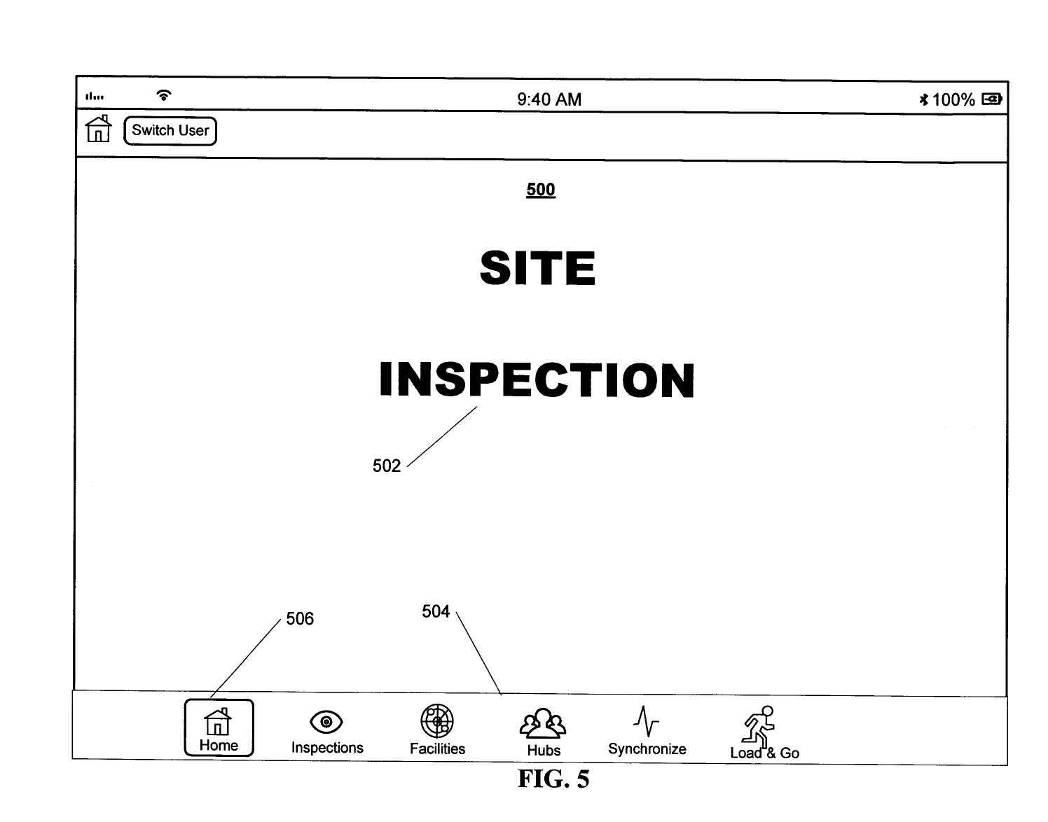

FIG. 5 depicts a home screen 500. The home screen 500 may appear following a successful log-in using the log-on screen 400. A banner 502 or other texts or graphics may be displayed on the home screen 500. The banner 502 may be a watermark or other symbol that remains present in the background of the application during use of the various menus and interfaces described herein. The home screen 500 may have a menu or tab bar 504 on it. The menu bar 504 may be located at the bottom of the screen. The menu bar 504 may be repositionable to other locations on the home screen 500. The menu bar 504 may have various menu options as depicted on the home screen 500. For example, the menu bar 504 may have icons, text, or symbols representing tabs, applications or options available within the site inspection program. The icons shown in FIG. 5 are exemplary only. The home screen 500 may selected by using the home icon 506 in the menu bar 504. The home screen 500 may be brought up at any time using this home icon 506.

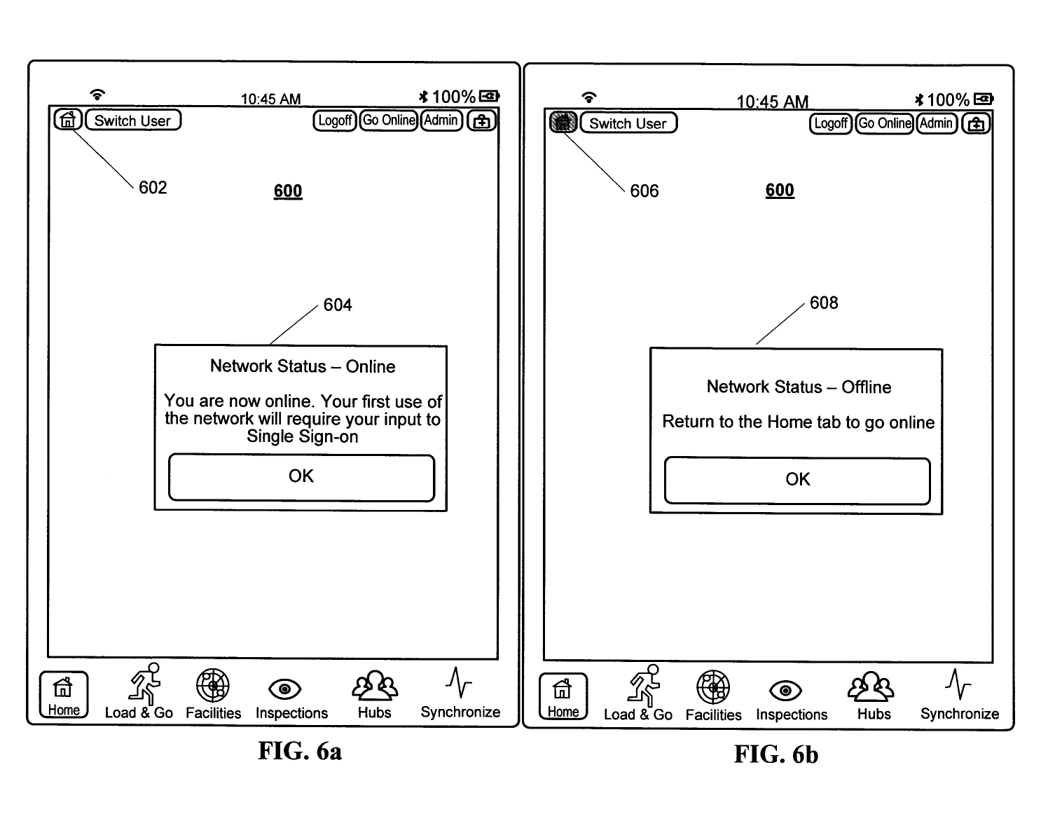

FIGS. 6a and 6b depict a network connectivity status screen 600. In the application an icon, such as icon 602, may be present on the periphery of the screen. Icon 602 may depict the status of the network connectivity which may allow a user to know if they are connected to the computer network associated with the site inspection application. As should be appreciated, this connectivity may differ from the computing device itself being connected to a wireless or wired network. According to exemplary embodiments, the connectivity status screen 600 may appear following power on of the device and prior to the log-on screen 400. Network connectivity may be necessary for a successful log-on.

The icon 602 may be interactive such that the user may click it and a status box 604 may appear providing details of the network connectivity. In FIG. 6b, icon 606 is shaded or otherwise modified to show a lack of connectivity. Upon interaction with the icon 606, a status box 608 may appear providing the details of network connectivity. According to some embodiments, the status boxes 604 and 608 may automatically appear on the screen when the network connectivity status changes. For example, the computing device may lose connectivity and status box 608 may appear; when connectivity is reestablished, the status box 604 may automatically appear. The status boxes 604 and 608 may disappear are a predetermined time interval.

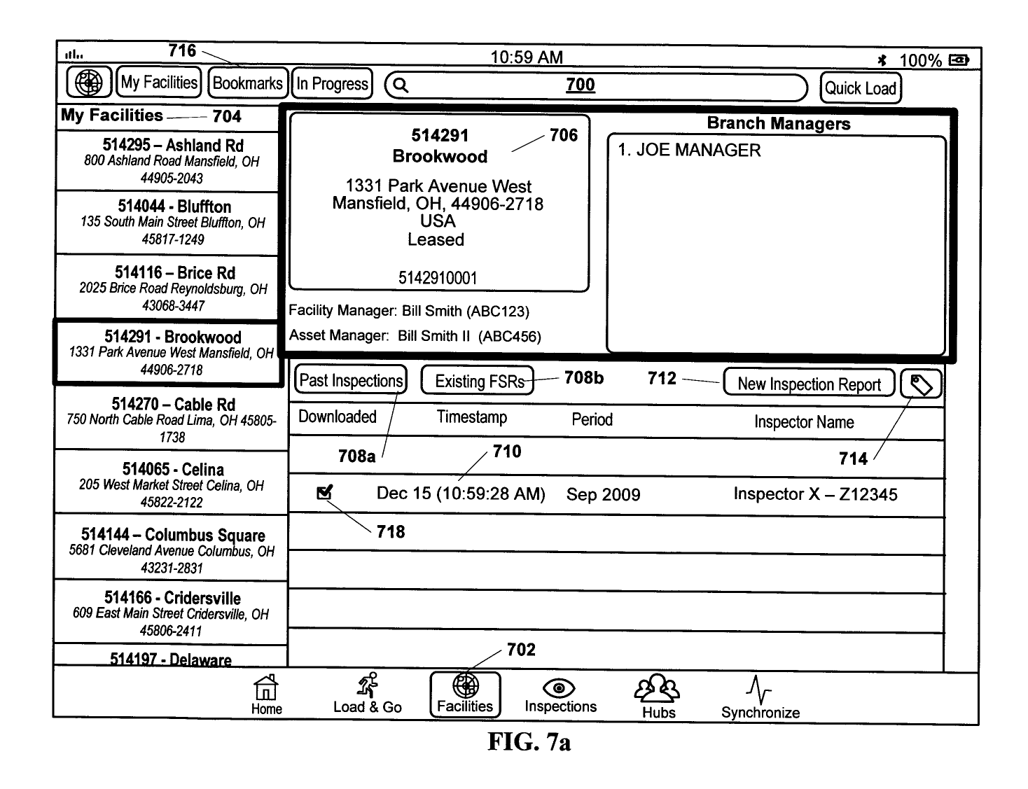

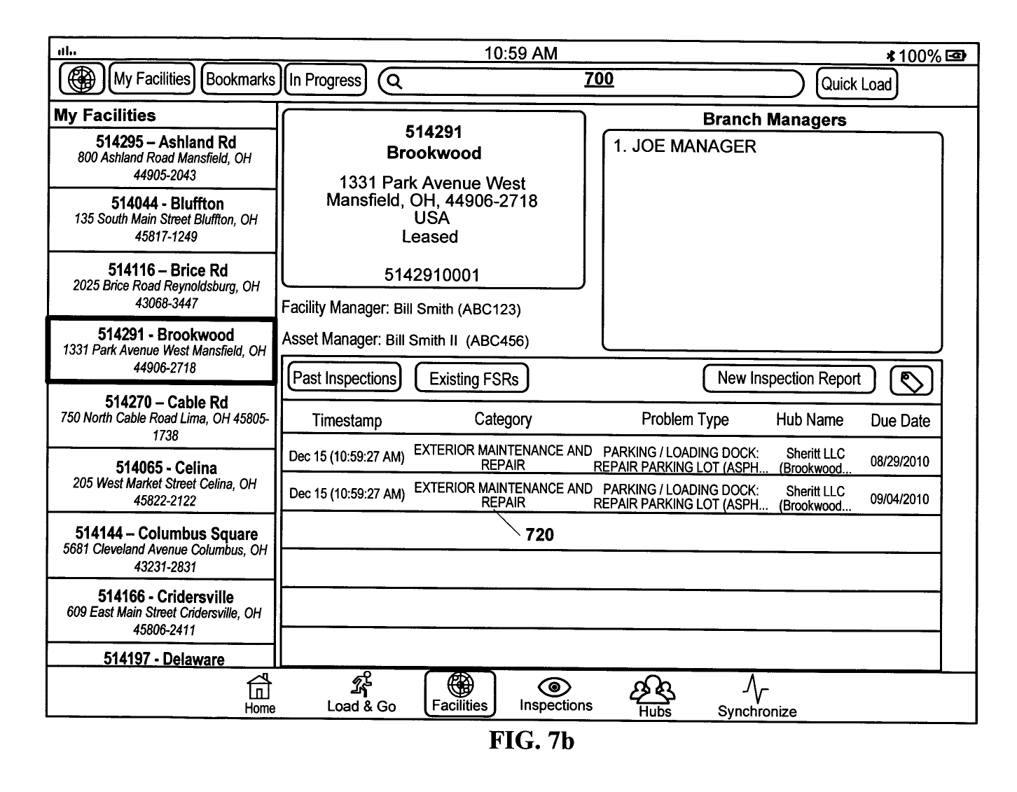

FIGS. 7a and 7b depict an assigned facilities screen 700. This screen may be brought up by using the facilities icon 702. The assigned facilities screen 700 may provide a listing of facilities 704 associated with or assigned to the user who logged onto the application. For example, the user may be an inspector who has a particular area or region which he/she covers and the corresponding facilities to that area may be listed. In some embodiments, a listing of all available facilities or locations may be provided. Individual facilities on the listing 704 may be selected to provide additional details 706 on that facility. The additional details 706 may be provided in a larger window or frame in the display. A pop-up window may be used. Various details and information about the selected facility may be provided such as location, facility manager information, branch manager information, and inspection information 708a and 708b, including information about past inspections and field service requests (“FSR”). The FSRs listing may be those that are outstanding or open.

When selecting a detail option, the information may populate a listing 710. For example, a past inspection report is shown at listing 710. This listing may be generated upon selection of the detail option. For example, selecting the past inspection option 708a may generate the listing 710. Past inspection reports may be grouped by various criteria and such criteria may be searchable by the user. At listing 720, a FSR listing is shown. This FSR listing may be generated by selecting the existing FSRs button 708b. This information (i.e., the past inspections and existing FSRs) may be downloaded and cached to the computing device for future access. Each entry in the listing 710 and 720 may be selectable to provide the details of the entry. An indication 718 of when the information is downloaded (and hence available for access) may be provided.

A new inspection report may be generated using button 712. A bookmark tab 714 may allow a user to bookmark a particular facility for faster access in the future. Once bookmarked using the bookmark tab 714, bookmarked items may be reviewed using the bookmarks button 716. In some embodiments, the bookmarks may be specific to the computing device. It should be appreciated that the facilities detail screen may be common for any selected facility, even if not selected from the my facilities listing 704.

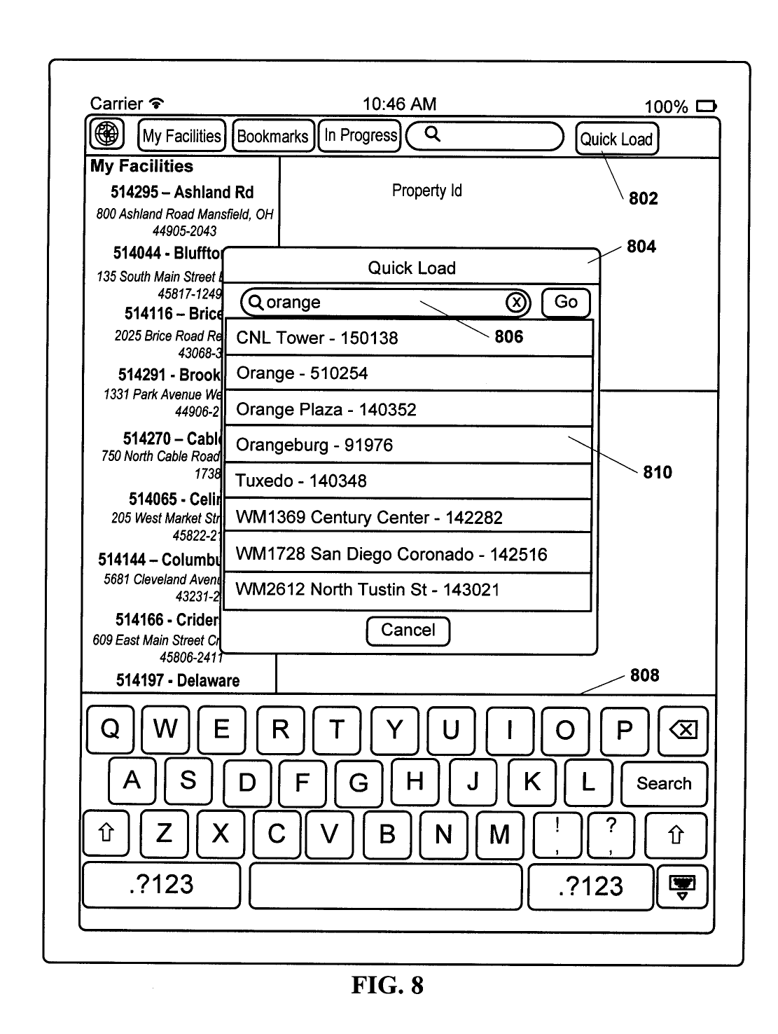

As shown in FIG. 8, the facilities screen may have a quick load button 802. Actuating or otherwise selecting this button may bring up a selection box 804 which has a search entry box 806 allowing the user to input a name to search for a particular location. A virtual keyboard 808 may appear on the display to facilitate entry of characters into the entry box 806. Upon entering characters into the entry box 806, a series of results 810 may be dynamically displayed. The results 810 may be updated as entry continues in the entry box 806. A particular result may be selected from the results 810 and the corresponding data may be displayed for that location as shown in FIG. 700.

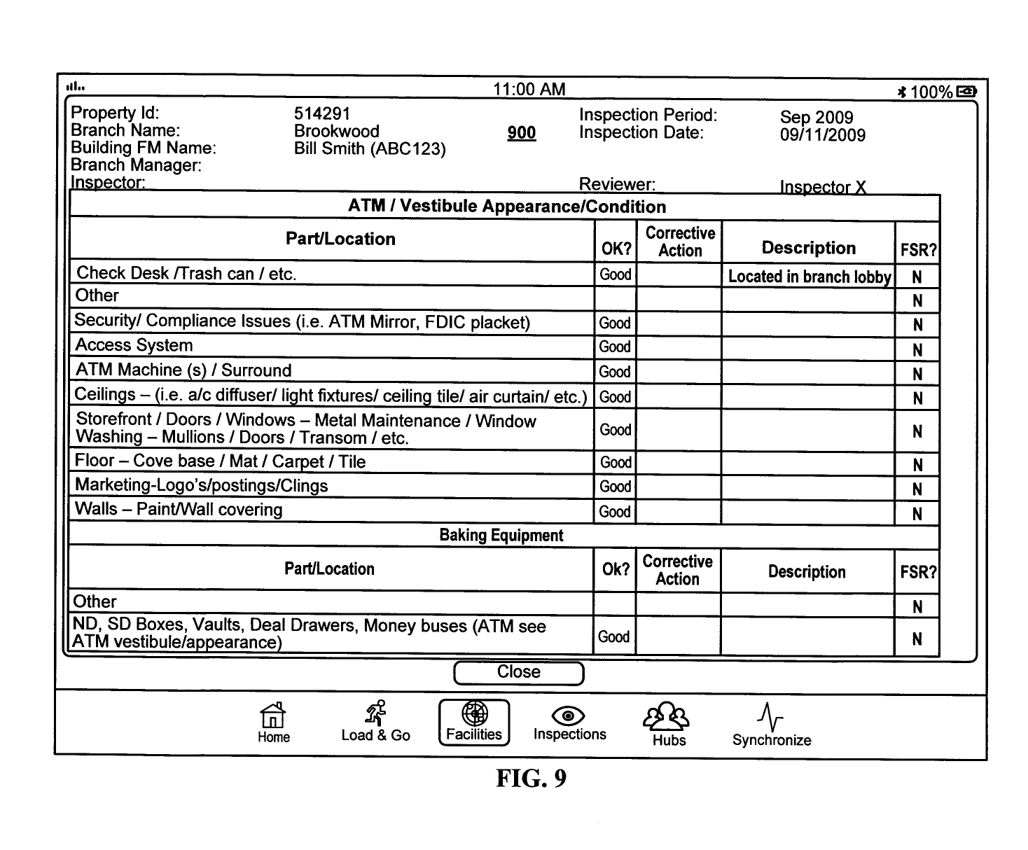

An example past inspection report 900 is depicted in FIG. 9. As described above, this report may be accessed by selecting an item in the listing 710. The inspection report may have the various details of the inspection. Active links may be provided in the inspection report to related documentation. For example, links may be provided to FSRs or the inspector comments from the inspection.

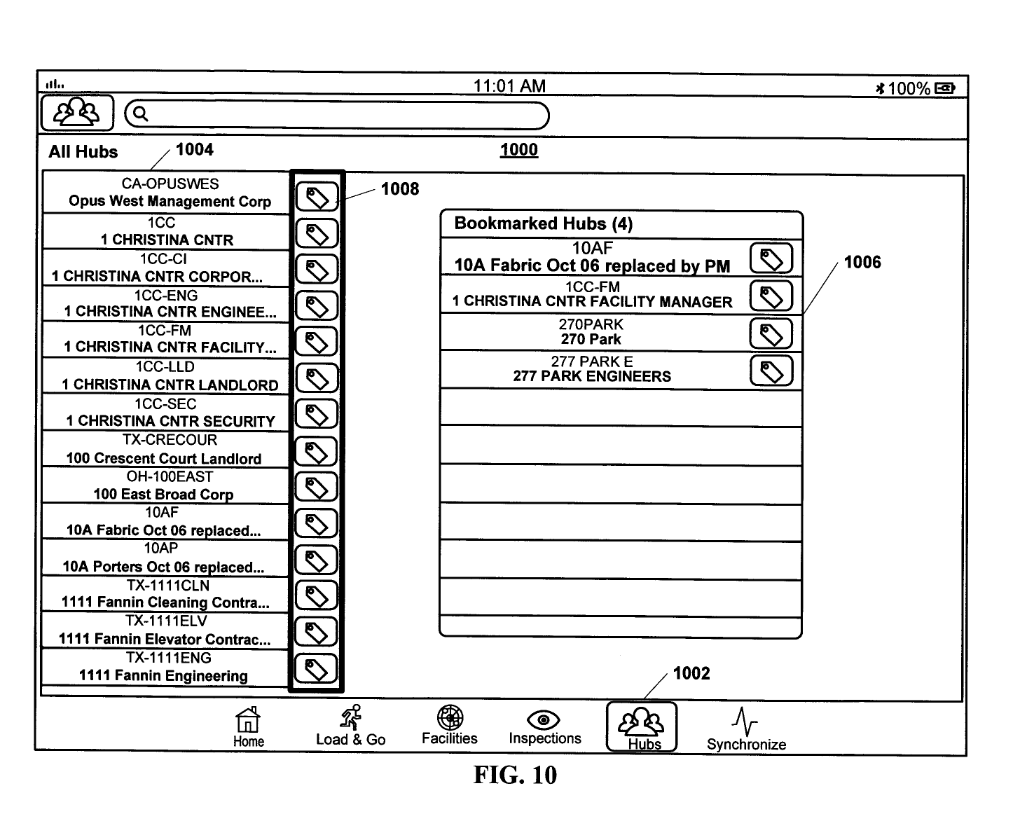

On the menu bar 504, a hubs icon 1002 may be used to bring up a hub screen 1000 as shown in FIG. 10. The hub screen 1000 may have a listing of hubs 1004 and a listing of bookmarked hubs 1006. The hubs may represent grouping of various facilities, locations, or departments. A hub may be a listing of preferred vendors or contractors for a particular area, problem, or grouping. A hub may be composed of multiple entries. A hub may be bookmarked by using the bookmark icon 1008 next to the hub name. The bookmarked hubs may be accessed through the bookmarked hubs 1006 listing or through the bookmark button 716 (as shown in FIG. 7 for example). In some embodiments, the bookmarks may be specific to the computing device.

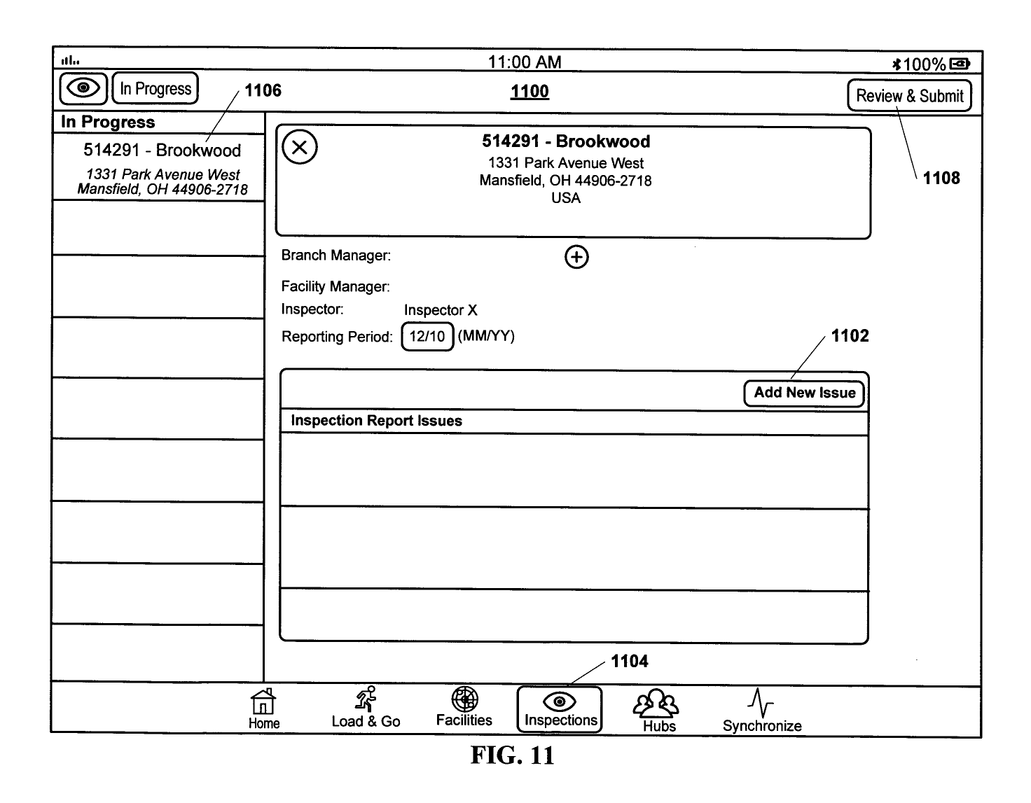

As shown in FIG. 7, a new inspection report may be commenced using button 712. Once button 712 is selection, the inspection report screen 1100 may be displayed as shown in FIG. 11. Inspection report screen 1100 may display information regarding the selected facility. An add new issue button 1102 may be available to allow entry of inspection issues, which would be displayed upon the listing below the button 1102. Provided on inspection report screen is a listing of in progress or open inspections 1106 for the user. Screen 1100 may have a review and submit button 1108 to allow closing of the inspection. Inspection report screen 1100 may be reached also by selection the inspections icon 1104 located on the menu bar 504.

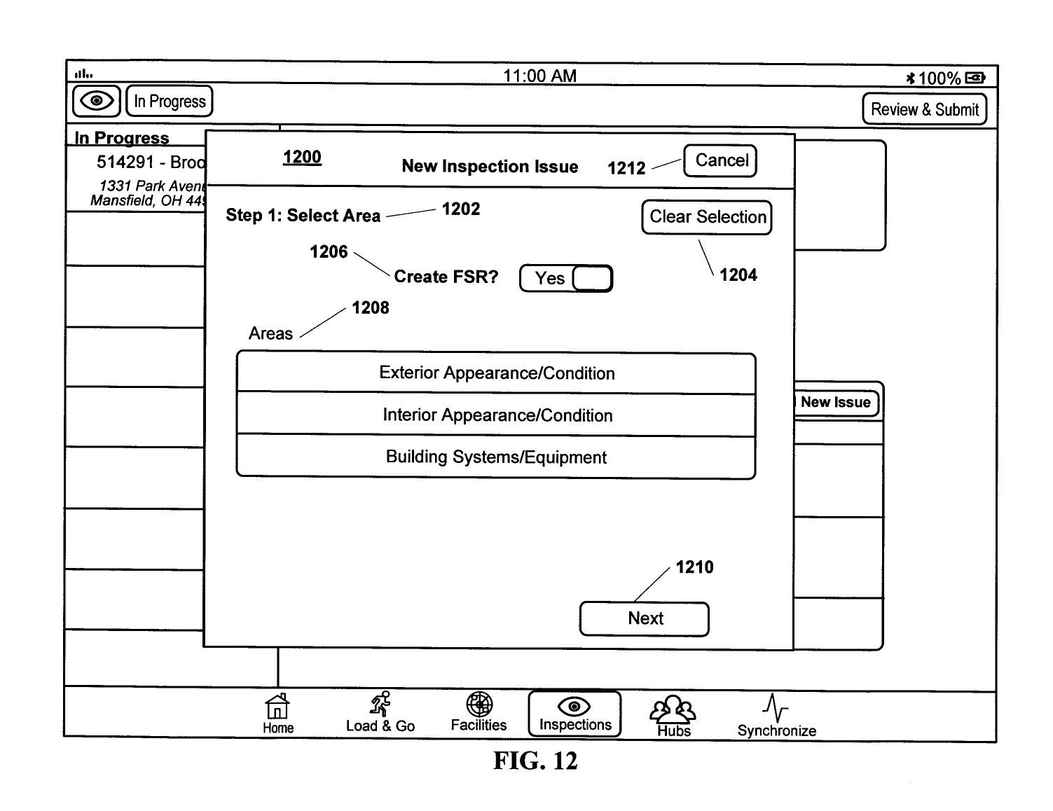

As shown in FIG. 12, upon selecting an add new issue button 1102, a new inspection issue window 1200 may appear. This window 1200 may represent a first step 1202, such as selecting an area, in the inspection issue process. A clear selection button 1204 may be provided to allow clearing of any entry that is incorrect. A create FSR option 1206 may be presented. For example, the create FSR option may be a “yes” or “no” option. It should be appreciated that the use of the term “FSR” is not meant to be limiting and a term representing an equivalent report or submission may be used in other embodiments. For example, FSR may be replaced with deficiency report, maintenance request, work order, or an equivalent report or request regarding a deficiency. An area selection region 1208 may be displayed. In the region 1208, an appropriate area designation may be selected from a supplied listing. The depicted designations are exemplary only. Upon completion of the selections on the window 1200, the next button 1210 may be selected to proceed to the next step. A cancel button 1212 may be provided which will terminate the new inspection issue addition process and close the window 1200.

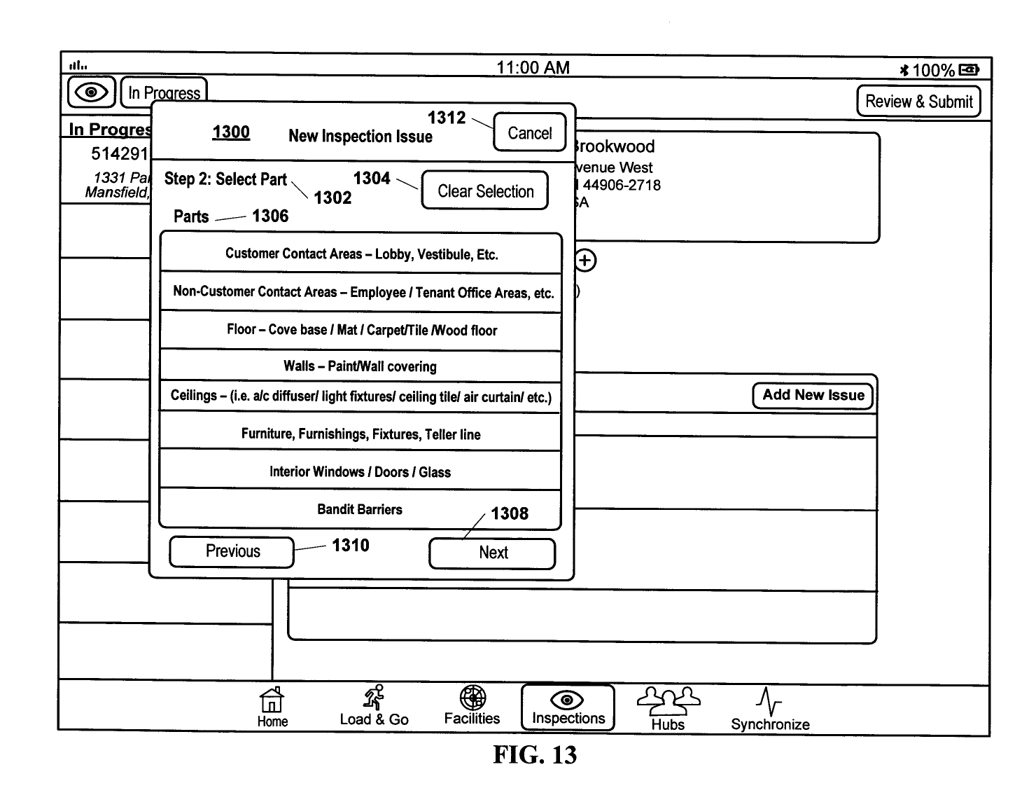

The next step after window 1200 may be an issue window 1300, as shown in FIG. 13, which may be the select part 1302 step. A clear selection button 1304 may be provided to allow clearing of any entry that is incorrect. A part selection region 1306 may be displayed from which the user may select an appropriate part. Upon completion of the selections on the window 1300, the next button 1308 may be selected to proceed to the next step. A previous button 1310 may also be provided to allow a return to the previous step. A cancel button 1312 may be provided which will terminate the new inspection issue addition process and close the window 1300.

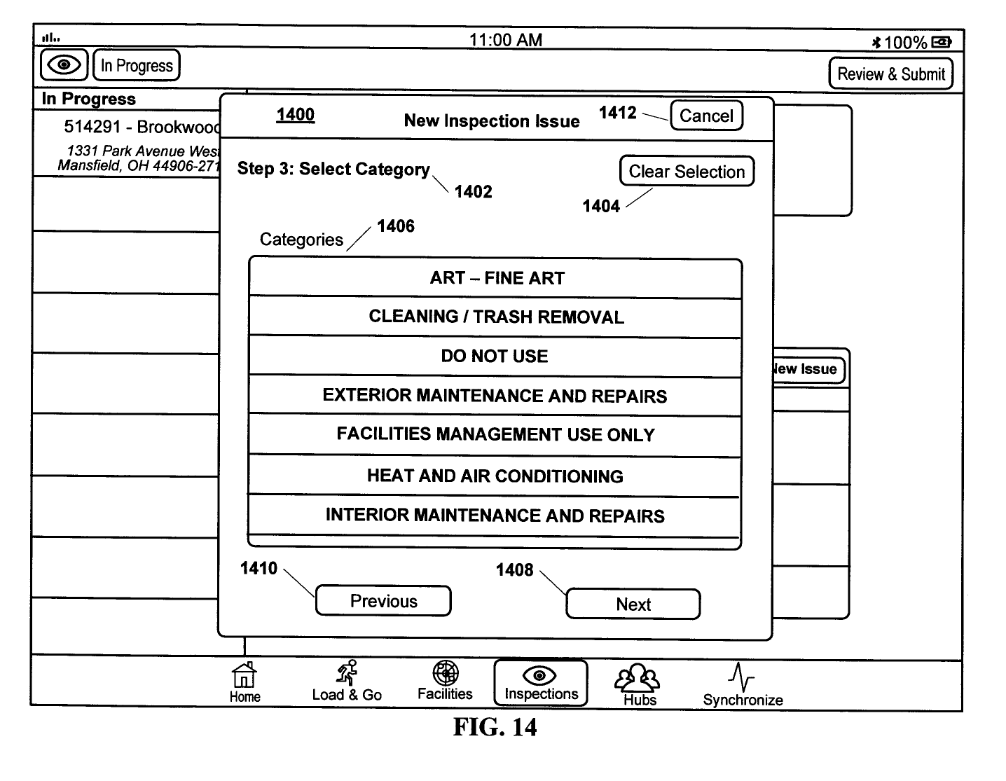

The next step after window 1300 may be a category window 1400, as shown in FIG. 14, which may be the select category 1402 step. A clear selection button 1404 may be provided to allow clearing of any entry that is incorrect. A categories listing 1406 may be provided from which an appropriate category may be selected. Upon completion of the selections on the window 1400, the next button 1408 may be selected to proceed to the next step. A previous button 1410 may also be provided to allow a return to the previous step. A cancel button 1412 may be provided which will terminate the new inspection issue addition process and close the window 1400.

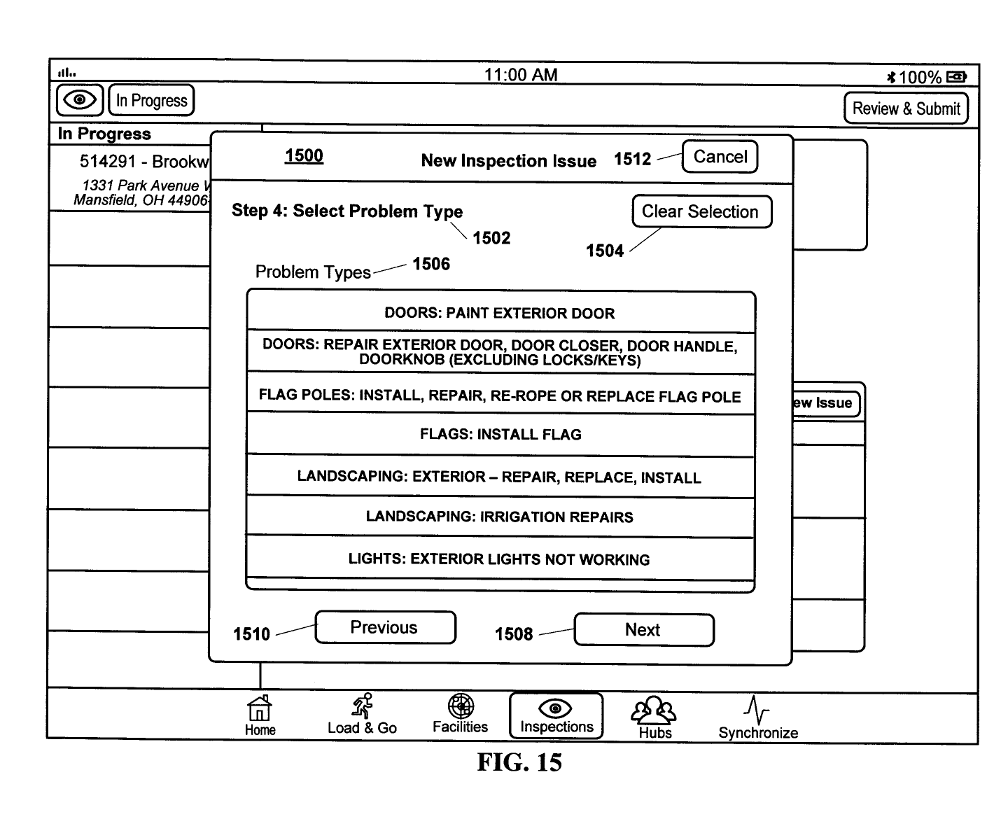

The next step after window 1400 may be a category window 1500, as shown in FIG. 15, which may be the select problem type 1502 step. A clear selection button 1504 may be provided to allow clearing of any entry that is incorrect. A problem type listing 1506 may be provided from which an appropriate category may be selected. Upon completion of the selections on the window 1500, the next button 1508 may be selected to proceed to the next step. A previous button 1510 may also be provided to allow a return to the previous step. A cancel button 1512 may be provided which will terminate the new inspection issue addition process and close the window 1500.

An additional portion of the above step may be to upload a digital image of the problem. The digital image may be taken using a digital imaging device that is part of the computing device. For example, the computing device may have an integrated digital camera. This digital camera may be used to take one or more digital images of the problem. These images may be added to the inspection issue. The application may accept a wide variety of image formats and sizes. The application may use a particular image format and may perform an image file conversion on the images uploaded or designated for upload.

According to some embodiments, a separate digital imaging device may be used. For example, the user may use a digital camera or a digital camera associated with a separate computing device to take one or more digital images. The application may allow for transfer of these images from the separate device to the computing device. The images may then be uploaded or transferred to the application as part of the inspection issue process. A transfer connection between the devices may be used as known in the art. For example, a wireless connection, such as bluetooth, or a wired connection, such as firewire or USB, may be used for the image data transfer between the devices. Appropriate options to allow this transfer may be provided in the form of buttons or other interfaces.

The computing device may have a microphone or other audio input device associated therewith. The user may use the microphone to record a narrative of the issue problem. This narrative may be saved as an audio file and included in the inspection report. The application may accept a wide variety of audio file formats. The application may use a particular audio file format and may perform a file conversion on the audio file uploaded or designated to be uploaded. Appropriate options to allow the use of such audio files may be provided in the form of buttons or other interfaces.

While the steps of adding additional content to the inspection issue, such as images and audio, have been described as part of the window 1500, these steps may be performed with other steps in the process. Alternatively, a separate window or windows may be used for these additions. An appropriate link or action button may be provided from an existing window to facilitate the selecting of the images and/or the audio file(s).

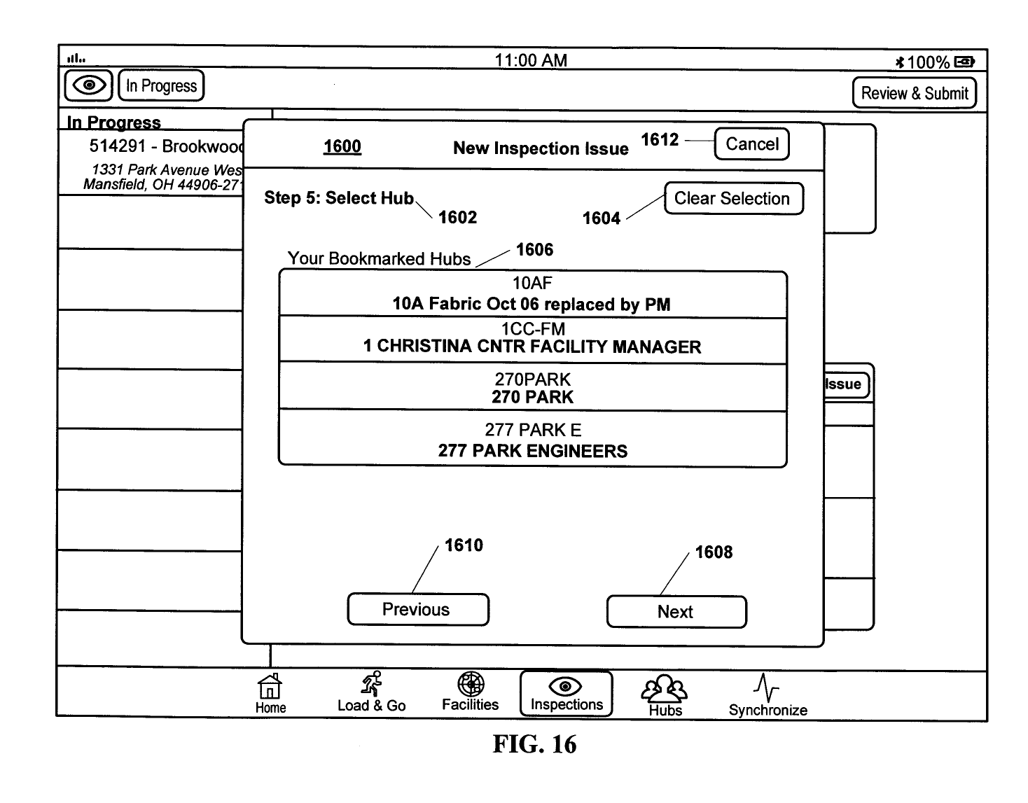

The next step after window 1500 may be a hub selection window 1600, as shown in FIG. 16, which may be the select hub 1602 step. A clear selection button 1604 may be provided to allow clearing of any entry that is incorrect. A hub listing 1606 may be provided from which an appropriate category may be selected. Upon completion of the selections on the window 1600, the next button 1608 may be selected to proceed to the next step. A previous button 1610 may also be provided to allow a return to the previous step. A cancel button 1612 may be provided which will terminate the new inspection issue addition process and close the window 1600.

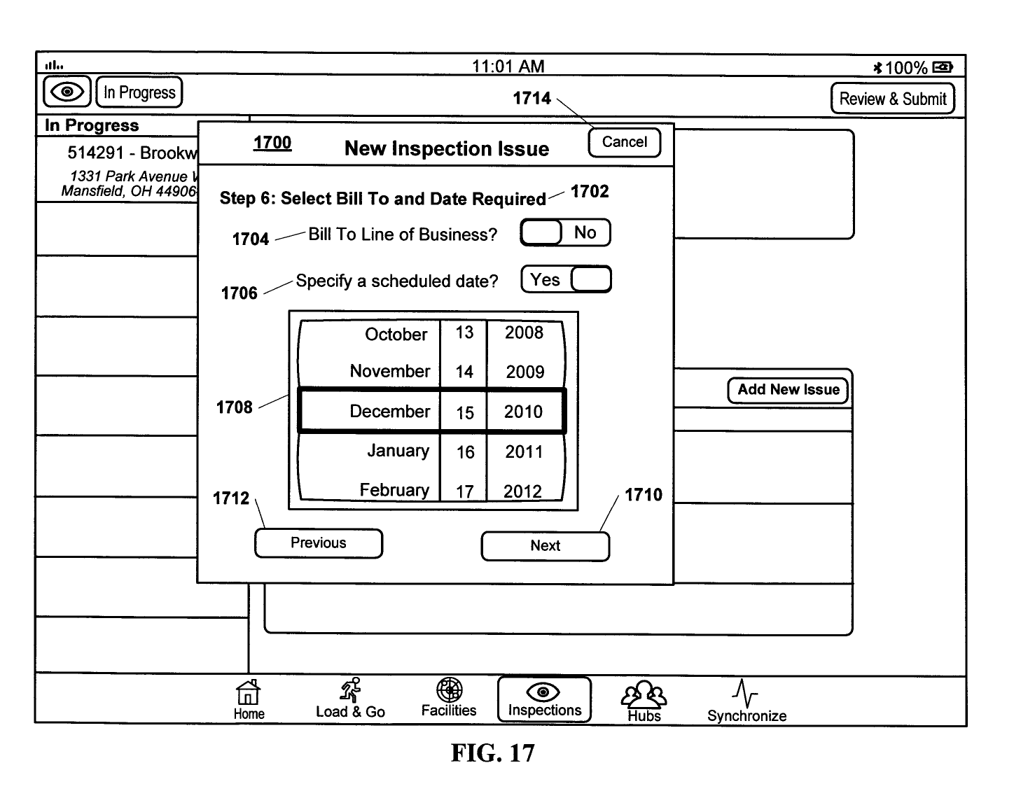

The next step after window 1600 may be a date selection window 1700, as shown in FIG. 17, which may be the select bill to and date required 1702 step. A bill to option 1704 may be provided from which a yes or no option may be selected. A date scheduled option 1706 may be provided to specify whether a scheduled date is to be selected. The scheduled date may represent the date correction is required by or a date on which a re-inspection may occur. If a “yes” is selected at 1706, then a date may be selected from the calendar display at 1708. While one type of calendar display is shown, other types such as a 30 day calendar may be used. Upon completion of the selections on the window 1700, the next button 1710 may be selected to proceed to the next step. A previous button 1712 may also be provided to allow a return to the previous step. A cancel button 1714 may be provided which will terminate the new inspection issue addition process and close the window 1700.

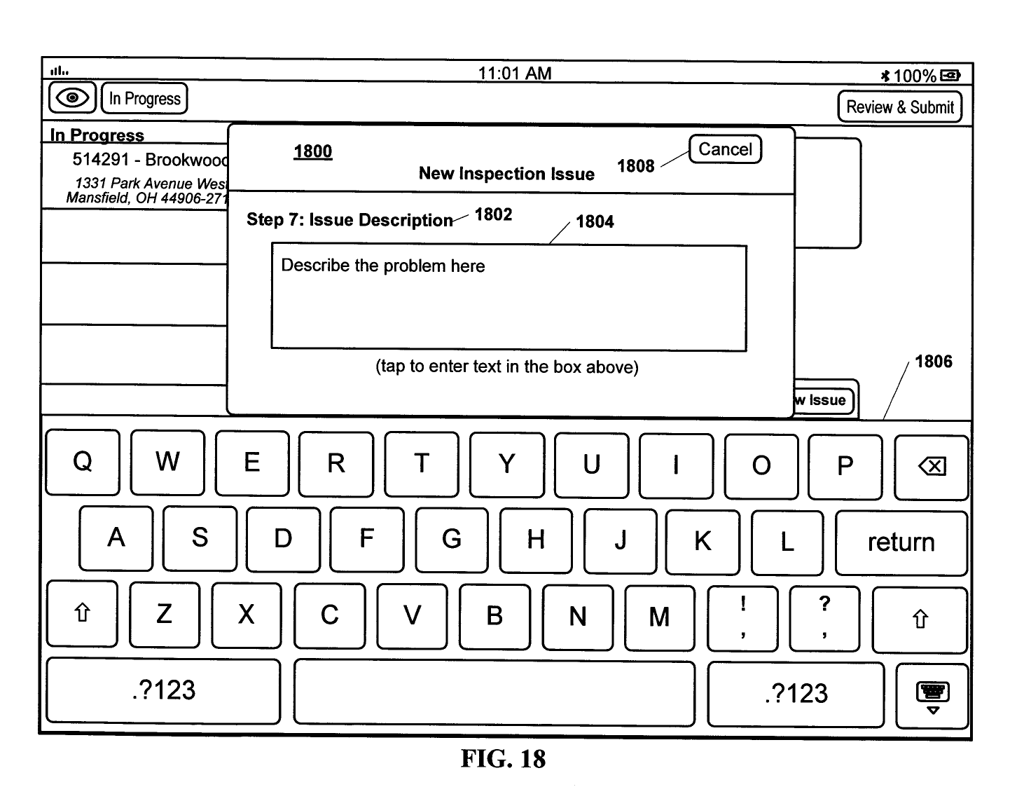

The next step after window 1700 may be an issue description window 1800, as shown in FIG. 18, which may be an issue description 1802 step. A text entry window 1804 may be provided for entry of a description of the issue. A virtual keyboard 1806 may be provided. Upon completion of the selections on the window 1800, the new inspection issue addition is completed. Upon entering of the text in the text entry window 1804, the issue may be completed. A cancel button 1808 may be provided which will terminate the new inspection issue addition process and close the window 1800.

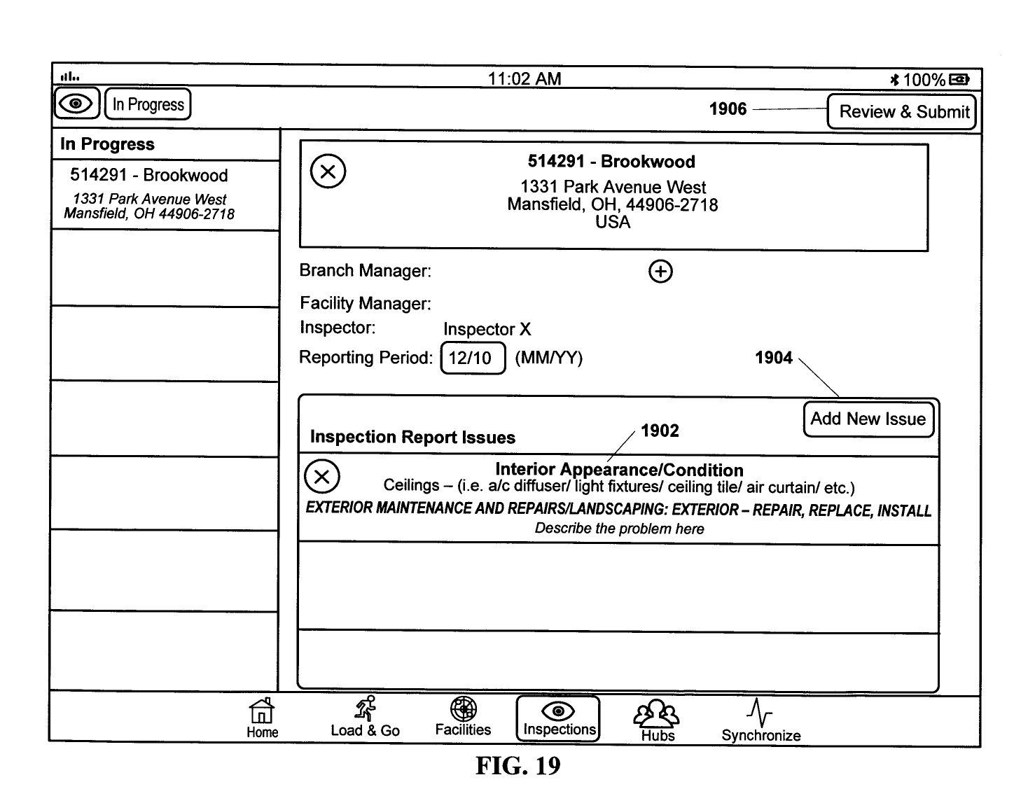

Once the new inspection issue is completed, it may appear on the listing of inspection report issues as an entry 1902 as shown in FIG. 19. The user may elect to add one or more additional new issues using the button 1904. The inspection may be reviewed for submission using button 1906.

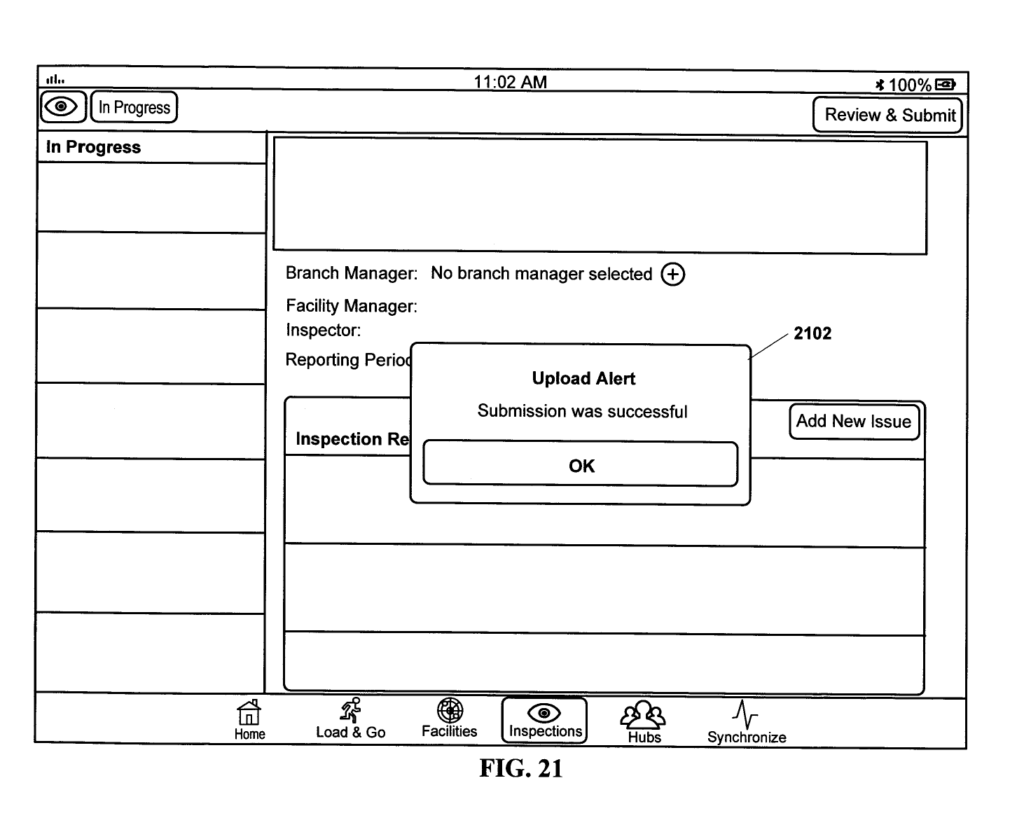

When button 1906 is actuated, a review of the inspection report may be conducted. A draft 2000 of the inspection report may be presented. The draft report 2000 may be reviewed. Upon completion of the review, the user may elect to submit 2002 or cancel 2004. Upon submission, the report may be forwarded through the system to the appropriate destination(s). For example, the report may be transmitted over a computer network, such as a local area network or the Internet, to one or more servers. Upon receipt at the one or more servers, additional processing of the inspection report may occur. The inspection report may then be available for other parties and users to access using the application as described above. Upon cancelling, the user may be returned to the inspection screens for modification or additions to the report. Upon submission of the report, the user may receive an upload alert 2102 regarding the report as shown in FIG. 21.

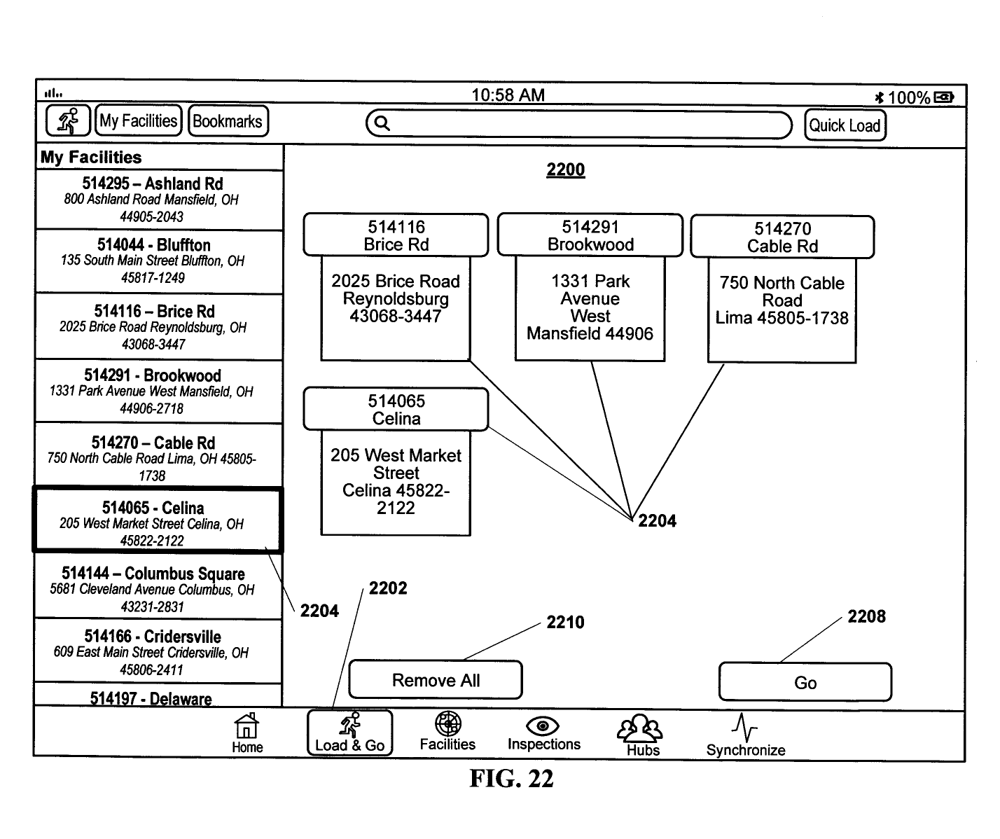

FIG. 22 depicts a load and go screen 2200. This screen may be selected by selecting the load and go icon 2202 in the menu bar 504. From this screen, a number of locations or facilities may be selected as shown by selections 2204 from the facilities listing. Once selected from the listing, the selections are placed into an area 2204. The user may select the go button 2208 or the remove all button 2210 to complete the actions. The button 2208 downloads information related to each of the selected facilities. The button 2210 removes all the selections and allow the user to start over. The load and go feature may users to download data for future use. The downloaded data may be cached for use by the computing device in the event that network connectivity is not available for real time updates. The caching may improve speed of access to the data since the data may be pulled locally from the computing device instead of over the network. The cached data may be automatically updated at periodic intervals by the application or the server.

While the above method has been described in terms of performing an inspection and identifying deficiencies, which may be termed a reactive method, exemplary embodiments may be used for proactive methods. Using a proactive reporting method, deficiencies and other conditions may be identified and corrected prior to inspections. Using a such a proactive method may allow more people to be involved in the reporting process which may allow for more sets of eyes to identify deficiencies.

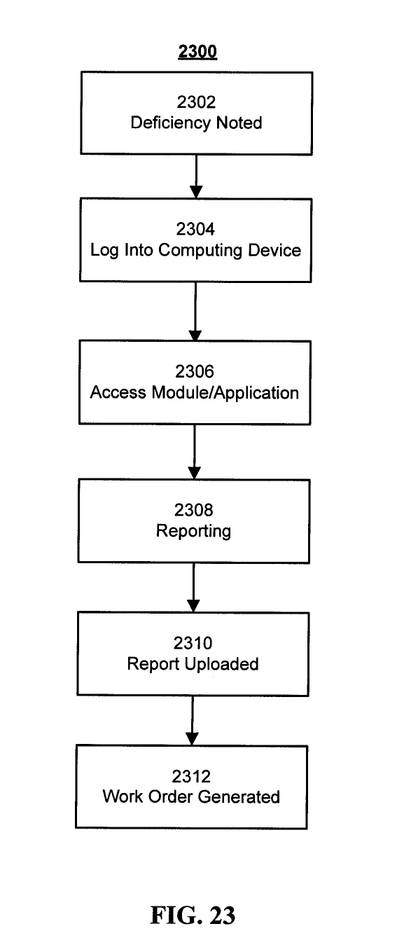

FIG. 23 depicts a flow chart of a method of proactive reporting using a computing device according to exemplary embodiments of the invention. Exemplary method 2300 is provided by way of example, as there are a variety of ways to carry out the methods disclosed herein. The method 2300 as shown in FIG. 23 may be executed or otherwise performed by one or a combination of various systems, such as a computer implemented system. Each block shown in FIG. 23 represents one or more processes, methods, and/or subroutines carried out in the exemplary method 2300. Each block may have an associated processing machine or the blocks depicted may be carried out through one processor machine.

While the following method may be illustrated using certain examples, such as a site inspection of a facility, these examples are meant to be exemplary and non-limiting.

At block 2302, a deficiency is noted. The deficiency may be noted by an employee or other person at a location. For example, an employee of a corporate entity or business may notice a cracked window at their work location.

At block 2304, a computing device is logged into. The computing device may be a workstation or a portable computing device. For example, the employee may log into their desktop computer. Alternatively, the employee may log into a portable electronic device such as a tablet computing device. This device may be associated with their employer; that is, the portable electronic device may have been issued to them to perform their job by the employer. In some embodiments, the computing device may be a personal computing device belonging to that employee. For example, the computing device may be a personally owned portable electronic device of the employee.

At block 2306, a module is accessed. The module may be an application, a widget, or other computer based software. The module may be firmware or hardware. For example, the employee may start or open an application on the computing device. The module may be a website on a computer network, such as a local area network or the Internet. For example, the employee may open a web browser and proceed to a designated website.

At block 2308, the condition or deficiency is reported. The condition or deficiency may be reported using the module. The module may have a series of menus or interfaces to assist with the reporting. The interfaces may be similar to those described above in FIGS. 4 through 22. Other menus or interfaces may be used. The module may allow for uploading of a digital image or code associated with the condition or deficiency as described above.

At block 2310, the report is uploaded. The condition or deficiency may be submitted through the module. The report may then be forwarded for processing.

At block 2312, a work order is generated. As described in at least FIG. 1 above, a work order corresponding to the deficiency may be generated. Once generated, the method 2300 may follow the steps of method 100 for correction of the deficiency identified in the work order.

Hereinafter, aspects of implementation of the inventions will be described. As described above, the method of the invention may be computer implemented as a system. The system of the invention or portions of the system of the invention may be in the form of a “processing machine,” for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

The description of exemplary embodiments describes servers, portable electronic devices, and other computing devices that may include one or more modules, some of which are explicitly depicted in the figures, others are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices (e.g., servers) instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, portable electronic devices, client devices, computers, etc.) separately. The functions described as being performed at various components may be performed at other components, and the various components may be combined and/or separated. Other modifications also may be made.

According to exemplary embodiments, the systems and methods may be computer implemented using one or more computers, incorporating computer processors. The computer implementation may include a combination of software and hardware. The computers may communicate over a computer based network. The computers may have software installed thereon configured to execute the methods of the exemplary embodiments. The software may be in the form of modules designed to cause a computer processor to execute specific tasks. The computers may be configured with hardware to execute specific tasks. As should be appreciated, a variety of computer based configurations are possible.

The processing machine described above may also utilize any of a wide variety of other technologies including a special purpose computer, a computer system including a microcomputer, mini-computer or mainframe for example, a programmed microprocessor, a micro-controller, a PICE (peripheral integrated circuit element), a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices for example capable of implementing the steps of the process of the invention.

It is appreciated that in order to practice the method of the invention as described above, it is not necessary that the processors and/or the memories of the processing machine be physically located in the same geographical place. For example, each of the processors and the memories and the data stores used in the invention may be located in geographically distinct locations and connected so as to communicate in any suitable manner. Additionally, it is appreciated that each of the processor and/or the memory and/or data stores may be composed of different physical pieces of equipment. Accordingly, it is not necessary that the processor be one single piece of equipment in one location and that the memory be another single piece of equipment in another location. For example, it is contemplated that the processor may be two or more pieces of equipment in two or more different physical locations. These two or more distinct pieces of equipment may be connected in any suitable manner. Additionally, the memory may include two or more portions of memory in two or more physical locations. Additionally, the data storage may include two or more components or two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions. It is also appreciated that the data storage performed by two distinct components as described above may, in accordance with a further embodiment of the invention, be performed by a single component. Further, the data storage performed by one distinct component as described above may be performed by two distinct components.

Further, various technologies may be used to provide communication between the various processors and/or memories, as well as to allow the processors and/or the memories of the invention to communicate with any other entity; e.g., so as to obtain further instructions or to access and use remote memory stores, for example. Such technologies used to provide such communication might include a network, such as a computer network, for example, the Internet, Intranet, Extranet, LAN, or any client server system that provides communication of any capacity or bandwidth, for example. Such communications technologies may use any suitable protocol such as TCP/IP, UDP, or OSI, for example. It should be appreciated that examples of computer networks used in the preceding description of exemplary embodiments, such as the Internet, are meant to be non-limiting and exemplary in nature.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming or any other suitable programming form. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. For example, written lines of programming code or source code, in a particular programming language, are converted to machine language using a compiler, assembler or interpreter. The machine language is binary coded machine instructions that are specific to a particular type of processing machine, e.g., to a particular type of computer, for example. The computer understands the machine language.

Any suitable programming language may be used in accordance with the various embodiments of the invention. Illustratively, the programming language used may include assembly language, Ada, APL, Basic, C, C++, C#, COBOL, dBase, Forth, Fortran, Java, Modula-2, Pascal, Prolog, REXX, Ruby, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, e.g., the software for example, that enables the computer operating system to perform the operations described above may be contained on any of a wide variety of computer readable media, as desired. Further, the data for example processed by the set of instructions might also be contained on any of a wide variety of media or medium. For example, the particular medium, e.g., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, e.g., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

While the embodiments have been particularly shown and described within the framework of inspections, such as building inspections, it will be appreciated that variations and modifications may be effected by a person of ordinary skill in the art without departing from the scope of the invention. Furthermore, one of ordinary skill in the art will recognize that such processes and systems do not need to be restricted to the specific embodiments described herein. Other embodiments, combinations of the present embodiments, and uses and advantages of the present invention will be apparent to those skilled in the art from consideration of the specification and practice of the invention disclosed herein. For example, the present invention may be effectively implemented for various maintenance, manufacturing, and industrial activities where review of structures, objects and processes may be required to document conditions and generate reports. These inspections may involve multiple persons at different locations where electronic management of the information is important. The specification and examples should be considered exemplary.

1. A computer implemented method, comprising:
receiving, by a computer processor of a first computing system, a request for data from a first computing device associated with a first user;
transmitting, electronically, by the first computing system, the requested data to the first computing device;
receiving, by the computer processor of the first computing system, from the first computing device, information comprising one or more deficiencies comprising that are defects or problems associated with at least one of a facility, a structure, and a piece of equipment;
receiving, by the computer processor of the first computing system, image data associated with the one or more deficiencies, wherein the image data is captured using a digital imaging device associated with the first computing device;
receiving, by the computer processor of the first computing system, location data associated with the image data that is generated using a Global Positioning System (GPS) capability associated with the first computing device;
generating, automatically, by the computer processor of the first computing system, a work order based on the one or more deficiencies, comprising one or more locations for the work order that are identified using the image data and the location data;
transmitting, electronically, by the first computing system, the work order to a second computing system; and
wherein the first computing system is associated with a first entity and the second computing system is associated with a second entity.

2. The computer implemented method of claim 1, wherein the first computing device comprises a portable electronic device.

3. The computer implemented method of claim 2, wherein the portable electronic device comprises a tablet computing device, a smart phone, or a laptop.

4. The computer implemented method of claim 1, wherein the data comprises data associated with one or more facilities or locations.

5. The computer implemented method of claim 1, wherein the information further comprises inspection results relating to a facility or location.

6. The computer implemented method of claim 5, wherein the inspection results comprise a report relating to the facility.

7. (canceled)

8. The computer implemented method of claim 1, further comprising:
transmitting, electronically, by the second computer system, the work order to a second computing device associated with a second user, the work order further comprising access information for the one or more locations associated with the work order and the second computing device comprises an access module that is activated by the presence of the second computing device at the one or more locations such that the access module provides necessary access codes and security information to gain entry to the one or more locations;
receiving, by the second computer system, updates to the work order from the second computing device; and
transmitting, electronically, the updates to the first computing system.

9. The computer implemented method of claim 8, wherein the second computing device comprises a portable electronic device.

10. The computer implemented method of claim 9, wherein the portable electronic device comprises a tablet computing device, a smart phone, or a laptop.

11. A computer implemented system, comprising:
a first server comprising at least one computer processor;
a first computing device;
a digital imaging device associated with the first computing device;
a network communicatively coupling the first server and the first computing device; and
the first server configured to:
receive a request for data originating from an application on the first computing device;
transmit the data to the first computing device;
receive information, from the first computing device, comprising one or more deficiencies comprising defects or problems associated with at least one of a facility, a structure, and a piece of equipment;
receive image data associated with the one or more deficiencies, the image data being captured using the digital imaging device;
receive location data associated with the image data that is generated using a Global Positioning System (GPS) capability associated with the first computing device;
generate, automatically, based on the one or more deficiencies, a work order, comprising one or more locations for the work order that are identified using the image data and the location data; and
transmit the work order to a second server; and
wherein the first-server is associated with a first entity and the second server is associated with a second entity.

12. The computer implemented system of claim 11, wherein the first computing device comprises a portable electronic device.

13. The computer implemented system of claim 12, wherein the portable electronic device comprises a tablet computing device, a smart phone, or a laptop.

14. The computer implemented system of claim 11, wherein the data comprises data associated with one or more facilities.

15. The computer implemented system of claim 11, wherein the information further comprises inspection results relating to a facility.

16. The computer implemented system of claim 15, wherein the inspection results comprise a report relating to the facility.

17. (canceled)

18. The computer implemented system of claim 11, further comprising:
a database communicatively coupled to the first server containing at least the data.

19. The computer implemented system of claim 11, wherein the application is designed to facilitate and support entry of information relating to site inspections.

20. The computer implemented system of claim 11, wherein the first computing device is capable of caching the data received for use when the first computing device lacks a communicative coupling to the computer network.

21. The computer implemented method of claim 1, wherein the location data comprises GPS coordinates corresponding to a position of the image data.
